(19) United States
(12) Patent Application Publication
(10) Pub. No.: US 2012/0030396 A1
(43) Pub. Date: Feb. 2, 2012

(54) Decoupled Memory Modules: Building High-Bandwidth Memory Systems from Low-Speed Dynamic Random Access Memory Devices

(76) Inventors: Zhichun Zhu, Chicago, IL (US); Zhao Zhang, Ames, IA (US); Hongzhong Zheng, Sunnyvale, CA (US)

(21) Appl. No.: 13/145,750

(22) PCT Filed: Mar. 1, 2010
(86) PCT No.: PCT/US10/25783

§ 371 Date: Jul. 21, 2011

Related U.S. Application Data
(60) Provisional application No. 61/156,596, filed on Mar. 2, 2009.

(51) Int. Cl. G06F 13/28

(52) U.S. Cl. 710/308

(57) ABSTRACT

Apparatus and methods related to exemplary memory system are disclosed. The exemplary memory systems use a synchronization device to increase channel bus data rates while using relatively-slower memory devices operating at device bus data rates that differ from channel bus data rates.

### RELATED APPLICATIONS

The present application claims priority to U.S. Provisional Patent Application No. 61/156,596 entitled “Decoupled DIMM: Building High-Bandwidth Memory System Using Low-Speed DRAM Devices,” filed Mar. 2, 2009, which is entirely incorporated by reference herein for all purposes.

This invention is supported in part by Grant Nos. CCF-0541408, CCF-0541366, CNS-0834469, and CNS-0834475 from the National Science Foundation. The United States Government has certain rights in the invention.

### BACKGROUND

In a conventional Double Data Rate (DDR) Dynamic Random Access Memory (DRAM) system (such as a DDR2 or DDR3 DRAM system), a memory bus connects one or more DRAM modules and one or more components that utilize data from the DRAM modules. For example, in a computer using a DDR2 or DDR3 memory system, the components might be processing units, input devices, and/or output devices connected to the memory system. The term “DDRx” is used herein to denote any memory system complying with one or more Joint Electronic Device Engineering Council (JEDEC) DDR standards (e.g., the DDR, DDR2, DDR3, and/or DDR4 standards).

FIG. 1 shows an example conventional DDRx memory system 100. A conventional DDRx memory system, such as memory system 100, in a workstation or server system has a small number (e.g., one to three) of memory channels, each with one to four memory modules, such as Single In-Line Memory Modules (SIMMs) or Dual In-line Memory Modules (DIMMs), in each channel. FIG. 1 shows memory system 100 with two memory channels, where each channel has one DIMM. For example, DIMM 110 and DIMM 120 of FIG. 1 can each include eight memory devices (MDs) 112a-112g and 122a-122g. Similarly, other prior art DIMMs are organized with either 4 or 16 memory devices. Each memory device provides one or more bits of data per operation (e.g., during a read or write operation). For example, in configurations where each of the eight memory devices 112a-112g can provide eight bits of data per transfer, then DIMM 110 can provide 64 bits of data per transfer. In this example, memory device 212a is termed an “8-bit” memory device.

In some embodiments, data in DIMMs 110, 120 is accessible via one or more “ranks” Each rank of a memory device is a logical 64-bit block of independently accessible data that uses one or more memory devices of the memory module; typically, DIMMs 110, 120 have two or more ranks As another example, a SIMM typically has one rank.

Memory controller 102 is connected to DIMMs 110, 120 via a channel bus 130 and respective device buses 140, 150. Memory system 100 is coordinated using a common clock 160 configured to produce clock signals 162 that are transmitted to memory controller 102 and DIMMs 110, 120. Clock signals are shown in FIG. 1 using dashed lines. DIMMs 110 and 120 are controlled by memory controller 102, which is configured to send memory requests (commands) and transfer data via channel bus 130. Upon receiving a request, such as a read request or a write request, a DIMM performs activities required to carry out the request.

For example, a typical read request directed to DIMM 110 would include row and column addresses to identify requested read data locations. DIMM 110 would then retrieve the read data based on the row and column address from all memory devices 112a-112g substantially simultaneously. As there are 8 memory devices in DIMM 110, and each memory device 112a-112g provides eight bits per operation, the retrieved read data would contain 64 bits in this architecture. DIMM 110 puts the 64 bits of read data on memory bus 140, which in turn connects to channel bus 130 for transfer to memory controller 102.

In another example, a typical write request directed to a DIMM 120 would include row and column addresses and write data to be written to DIMM 120 at locations corresponding to the requested row and column addresses. DIMM 120 would then “open,” or make memory devices 122a-122g accessible for writing, substantially simultaneously at the requested locations. As with the read data, the write data contains 64 bits—8 bits for each of memory devices 122a-122g. Once memory devices 122a-122g are open, DIMM 120 places the 64 bits of write data on memory bus 150 to write memory devices 122a-122g, which completes the write operation.

DDRx DRAM technology has evolved from Synchronous DRAM (SDRAM) through DDR, DDR2 and DDR3, to the planned DDR4 standard. Table 1 compares representative benchmark data for current DRAM generations.

TABLE 1

| | DRAM Device | | | | | | |
|---|---|---|---|---|---|---|---|
| | SDRAM- | DDR- | DDR2- | DDR3- | DDR3- | DDR3- | DDR3- |
| Benchmark | 133 | 400 | 800 | 800 | 1066 | 1333 | 1600 |
| Voltage (V) | 3.3 | 2.5 | 1.8 | 1.5 | 1.5 | 1.5 | 1.5 |
| Max. Capacity per | 512 Mb | 1 Gb | 2 Gb | 4 Gb | 4 Gb | 2 Gb | 1 Gb |
| Chip | | | | | | | |
| Bandwidth | 1066 | 3200 | 6400 | 6400 | 8533 | 10666 | 12800 |
| (MB/s/channel) | | | | | | | |
| Cycle time t_{CK} (ns) | 7.5 | 5 | 2.5 | 2.5 | 1.87 | 1.5 | 1.25 |
| Latency (cycles) | 3 | 3 | 6 | 6 | 8 | 9 | 11 |
| Burst length (cycles) | 8 | 4 | 4 | 4 | 4 | 4 | 4 |
| Tₚᵣₑ, T_{act}, T_{col} (ns) | 22.5 | 15 | 15 | 15 | 15 | 13.5 | 13.75 |
| Data burst time (T_{bl}) | 60 | 20 | 10 | 10 | 7.5 | 6 | 5 |
| (ns) | | | | | | | |

Generally speaking, the price of a DRAM device increases as bandwidth increases—that is, a DDR3-1600 DRAM device is typically more expensive than a DDR3-800 DRAM device.

Memory bandwidth has improved dramatically over time; for instance, Table 1 indicates the data transfer rate increases from 133 MT/s (Mega-Transfers per second) for SDRAM-133 to 1600 MT/s for DDR3-1600. The proposed DDR4 memory could reach 3200 MT/s. Thus, data burst time T_{N} (a.k.a. data transfer time) has been reduced significantly from 60 ns to 5 ns for transferring a 64-byte data block, as can be seen in Table 1 above. In contrast, data of Table 1 shows that internal DRAM device operation delay times, such as precharge time Tₚᵣₑ, row activation time T_{act} and column access time T_{col}, have only moderately decreased. As a consequence, data transfer time only accounts for a small portion of the overall memory idle latency without queuing delay.

Power consumption of a DRAM memory device has been classified into four categories: background power, operation power, read/write power and I/O power. Background power is consumed constantly, regardless of DRAM operation. Current DRAM memory devices support multiple low power modes to reduce background power when a DRAM chip is not operating. Operation power is consumed when a DRAM memory device performs activation or precharge operations. Read/write power is consumed when data are read out or written into a DRAM memory device. I/O power is consumed to drive the data bus and terminate data from other ranks as necessary. For DRAM memory devices, such as DDR3 DIMMs, multiple ranks and chips are involved for each DRAM access; and the power consumed during a memory access is the sum of power consumed by all ranks/chips involved.

Table 2 gives the parameters for calculating the power consumption of various conventional Micron 1 Gbit DRAM devices, including background power values (the non-operating power values in Table 2) for different power states, read/write power values, and operation power values for activation and precharge.

TABLE 2

| | DRAM Device | | | | | | | |
|---|---|---|---|---|---|---|---|---|
| Parameter | DDR3-800 | | DDR3-1066 | | DDR3-1333 | | DDR3-1600 | |
| Maximum data rate | 800 | MT/s | 1066 | MT/s | 1333 | MTs | 1600 | MT/s |
| Normal voltage | 1.5. | V | 1.5. | V | 1.5. | V | 1.5. | V |
| Operating active-precharge | 90 | mA | 100 | mA | 110 | mA | 120 | mA |
| Active standby | 50 | mA | 55 | mA | 60 | mA | 65 | mA |
| Self refresh fast mode | 7 | mA | 7 | mA | 7 | mA | 7 | mA |
| Self refresh slow mode | 3 | mA | 3 | mA | 3 | mA | 3 | mA |
| Operating burst read | 130 | mA | 160 | mA | 200 | mA | 250 | mA |
| Operating burst write | 130 | mA | 160 | mA | 190 | mA | 225 | mA |
| Active power-down current | 20 | mA | 30 | mA | 35 | mA | 40 | mA |
| Precharge power-down fast | 25 | mA | 25 | mA | 30 | mA | 35 | mA |
| mode | | | | | | | | |
| Precharge power-down | 10 | mA | 10 | mA | 10 | mA | 10 | mA |
| slow mode | | | | | | | | |

Table 2 shows that power consumption of these DRAM devices increases with data rate and so does the energy. Consider use of DDR3-800 devices in comparison with DDR3-1600 devices. For devices in the active standby state, the electrical current for providing the background power drops from 65 mA for DDR3-1600 devices to 50 mA for DDR3-800 devices. When the device is being precharged or activated, the current to provide the operational power in addition to background current drops from 120 mA for DDR3-1600 devices to 90 mA for DDR3-800 devices. When the device is performing a burst read, the current to provide the read power (which is addition to the background current) drops from 250 mA for DDR3-1600 devices to 130 mA for DDR3-800 device. Similarly, read current drops from 225 mA for DDR3-1600 devices to 130 mA for DDR3-800 devices. Therefore, with current technology, relatively-slow memory devices typically require less power than relatively-fast memory devices.

Several designs and products for memory devices use bridge chips to improve capacity, performance and/or power efficiency. For example, the Register DIMM system uses a register chip to buffer memory command/address between memory controller and DRAM devices. It reduces the electrical loads on the command/address bus so that more DIMMs can be installed on a memory channel. The MetaRAM system uses a MetaSDRAM chipset to relay both address/command and data between the memory controller and the devices, so as to reduce the number of externally visible ranks on a DIMM and reduces the load on the DDRx bus. The Fully-Buffered DIMM system uses high speed, point-to-point links to connect DIMMs via an AMB (Advanced Memory Buffer), to make the memory system scalable while maintaining signal integrity a high-speed channel. A Fully-Buffered DIMM channel has fewer wires than a DDRx channel, which means more channels can be put on a motherboard. A design called mini-rank uses a mini-rank buffer to break each 64-bit memory rank into multiple mini-ranks of narrower width, so that fewer devices are involved in each memory access.

The widespread use of multi-core processors has placed greater demands on memory bandwidth and memory capacity. This race to ever higher data transfer rates puts pressure on DRAM device performance and integrity. The current DDRx-compatible DRAM devices that can support 1600 MT/s data rate are not only expensive but also of low density. Some DDR3 devices have been pushed to run at higher data rates by using a supply voltage higher than the JEDEC DDR3 standard. However, such high-voltage devices consume substantially more power and overheat easily, and thus sacrifice reliability to reach higher data rates.

In conventional systems, such as the memory system of FIG. 1, the data rates of the DIMMs 110, 120 match the channel bus rate 132; e.g., channel bus rate 132 is 1600 MT/s in a memory system where DIMMs 110, 120 are DDR3-1600 devices. Thus, in conventional systems, channel bus 130 and device buses 140, 150 operate at the same bandwidth rate.

In practice, it is more difficult to increase the data rate at which a DRAM device operates than to increase the data rate at which a memory bus operates. Rather, as discussed above, prior memory systems transfer data from DRAM devices, such as DIMMs, at a device bus data rate that is no faster than a DRAM-device data rate.

### SUMMARY

In light of the foregoing, it would be advantageous to provide memory access at a bus data rate higher than a DRAM-device rate while improving the power efficiency of the memory system.

This application describes a decoupled memory module (MM) design that improves power efficiency and throughput of memory systems by allowing a memory bus to operate at a bus data rate that is higher than a device data rate of DRAM devices. The decoupled MM includes a synchronization device to relay data between the relatively-slower DRAM devices and the relatively-faster memory bus. Exemplary memory modules for use with the decoupled MM design include, but are not limited to, DIMMs, SIMMs, and/or Small Outline DIMMs (SO-DIMMs).

In one aspect of the disclosure of the application, one or more synchronization devices are provided. The one or more synchronization devices include a first bus interface, a buffer, a second bus interface, and a clock module. The first bus interface is configured to connect to a first bus. The first bus is configured to operate at a first clock rate and transfer data at a first data rate. The first bus interface includes a first control interface and a first data interface. The first control interface is configured to communicate memory requests based on the first clock rate. The first data interface is configured to communicate request-related data associated with the memory requests at the first data rate. The buffer is configured to store the memory requests and the request-related data. The buffer is also configured to connect to the first bus interface and to a second bus interface. The second bus interface is configured to further connect to a second bus and to one or more memory devices. The second bus is configured to operate at a second clock rate and transfer data at a second data rate. The second bus interface includes a second control interface and a second data interface. The second control interface is configured to transfer the memory requests from the buffer to the one or more memory devices based on the second clock rate. The second data interface is configured to communicate the request-related data between the buffer and the one or more memory devices at the second data rate. The clock module is configured to receive first clock signals at the first clock rate and generate second clock signals at the second clock rate. The first bus interface operates in accordance with the first clock signals. The second bus interface and the one or more memory devices operate in accordance with the second clock signals. The second data rate is slower than the first data rate.

In another aspect of the disclosure, one or more memory modules are provided. The one or more memory modules include a synchronization device, one or more memory devices, and a second bus. The synchronization device includes a first bus interface, a buffer, and a second bus interface. The first bus interface is configured to connect to a first bus operating at a first clock rate. The first bus is configured to communicate memory requests. The second bus is configured to connect the second bus interface with the one or more memory devices and to operate at a second clock rate. The one or more memory devices are configured to communicate request-related data with the synchronization device via the second bus in accordance with the memory requests at a second data rate based on the second clock rate. The synchronization device is configured to communicate at least some of the request-related data with the first bus at a first data rate based on the first clock rate. The second data rate is slower than the first data rate.

In yet another aspect of the disclosure, one or more methods are provided. Memory requests are received at a first bus interface via a first bus. The first bus is configured to operate at a first clock rate and to transfer data at a first data rate. The memory requests are sent to one or more memory modules via a second bus interface. The second bus interface is configured to operate at a second clock rate and transfer data at a second data rate. The second data rate is slower than the first data rate. In response to the memory requests, request-related data are communicated with the one or more memory modules at the second data rate. At least some of the request-related data are sent to the first bus via the first bus interface at the first data rate.

An advantage of this application is that exemplary decoupled MM memory systems permit memory devices in one or more memory modules to transfer data at a relatively-slower memory bus data rate while the channel bus and memory controller transfer data at a different relatively-higher channel bus data rate. For example, the channel bus data rate can be double that of the memory bus data rate. This decoupling of channel bus data rates and memory bus data rates enable overall memory system performance to improve while allowing memory devices to transfer data at relatively-slower memory bus data rates. Transferring data at the relatively-slower memory bus data rates permits memory devices to operate at the rated supply voltage (i.e., the specified supply voltages of the JEDEC DDR standards), thus saving power and increasing reliability and lifespan of the DRAM memory devices. Further, exemplary decoupled MM memory systems can use fewer memory channels than conventional memory systems to provide a desired memory bandwidth, thus simplifying and reducing the cost of circuit boards (e.g., motherboards) using decoupled MM memory systems. Exemplary decoupled MM memory systems can deliver greater memory bandwidth than conventional systems in scenarios where both decoupled MM memory systems and conventional memory systems with the same numbers of channels and with memory devices operating at the same clock rate.

Specific embodiments of the present invention will become evident from the following more detailed description of certain preferred embodiments and the claims.

### BRIEF DESCRIPTION OF THE DRAWINGS

Various examples of particular embodiments are described herein with reference to the following drawings, wherein like numerals denote like entities, in which:

FIG. 1 is a block diagram of a conventional memory system;

FIG. 2 is a block diagram of an exemplary memory system;

FIG. 3 is a block diagram of an exemplary synchronization device;

FIG. 4A is a timing diagram of a conventional memory system;

FIG. 4B is a timing diagram of an exemplary memory system;

FIG. 5 depicts a performance comparison of an exemplary memory system with conventional memory systems;

FIG. 6 depicts another performance comparison of exemplary memory systems with conventional memory systems;

FIG. 7 depicts a memory throughput comparison of an exemplary memory system with conventional memory systems;

FIG. 8 depicts a latency comparison of an exemplary memory system with conventional memory systems;

FIG. 9 depicts a power comparison of exemplary memory systems with conventional memory systems;

FIG. 10 depicts another performance comparison of exemplary memory systems with conventional memory systems;

FIGS. 11A and 11B each depict performance comparisons of exemplary memory systems using fewer memory channels than comparable conventional memory systems;

FIG. 12 is a block diagram of an exemplary computing device; and

FIG. 13 is a flowchart depicting exemplary functional blocks of an exemplary method for processing memory requests.

### DETAILED DESCRIPTION

Methods and apparatus are described for memory systems using an exemplary decoupled MM design, which breaks (or decouples) the 1:1 relationship of data rates between the channel bus and a single rank of DRAM devices in a memory module. Each memory module in an exemplary decoupled MM memory system can transfer data at a relatively-low data rate of a memory bus while the combined bandwidth of all memory modules can transfer data at rates that match (or exceed) a relatively-high data rate of a channel bus.

Each memory channel in an exemplary decoupled MM memory system includes more than one memory module mounted and/or each memory module of the decoupled MM memory system has more than one memory rank. As such, the sum of the memory bandwidth from all memory modules is at least double the memory bus bandwidth.

The exemplary decoupled MM design uses a synchronization device configured to relay data between the channel bus and the DRAM devices, so that the DRAM devices can transfer data at a lower device bus data rate. Two exemplary design variants of the synchronization device are described. The first design variant uses an integer ratio R of data rate conversion between the channel bus data rate m and the device bus data rate n, where n and m are integers, and n<m (and thus R>1). For example, if R is two, the channel bus data rate is double the device bus data rate. The second variant allows a non-integer ratio R between the between the channel bus data rate m and the device bus data rate n.

In other embodiments, memory accesses are scheduled to avoid any potential memory access conflicts introduced by differences in data rates. The use of a synchronization device incurs delay in data transfer, and reducing device data rate slightly increases data burst time, both contributing to a slight increase of memory latency. Nevertheless, analysis and performance comparisons show that the overall performance penalty is small when compared with a conventional DDRx memory system using the same relatively-high data rate at the bus and devices.

Although the synchronization device consumes a certain amount of extra power, the additional power consumed by the synchronization device is more than offset by the power saving from lowering the device data rate. The use of synchronization devices also has the advantage of reducing the electrical load on buses in the memory system. Thus, more memory modules can be installed in an exemplary decoupled MM memory system, which increases memory capacity. The use of the synchronization device is compatible with existing low-power memory techniques.

A memory simulator is also described. The memory simulator was used to generate performance data presented herein related to the exemplary decoupled MM memory system. Experimental results from the memory simulator show an exemplary decoupled MM memory system with 2667 Mega-Transfers per second (MT/s) channel bus data rate and 1333 MT/s device bus data rate improves the performance of memory-intensive workloads by 51% on average over a conventional memory system with a 1333 MT/s data rate. Alternatively, an exemplary decoupled MM memory system of 1600 MT/s channel bus data rate and 800 MT/s device bus data rate incurs only 8% performance loss when compared with a conventional system running at a 1600 MT/s data rate, while the exemplary memory system enjoys a substantial 16% reduction in memory power consumption.

By decoupling DRAM devices from the bus and memory controller, exemplary decoupled MM memory systems can improve the memory bandwidth by one or more generations while improving memory cost, reliability, and power efficiency. Specific benefits of exemplary decoupled MM memory systems include:

(1) Performance. In exemplary decoupled MM memory systems, DRAM devices are no longer a bottleneck as memory systems with higher bandwidth per-channel can be built with relatively slower DRAM devices. Rather, channel bus bandwidth is now limited by the memory controller and bus implementations.

(2) Power Efficiency. Overall, exemplary decoupled MM memory systems are more power-efficient and consume less energy than conventional memory systems. With exemplary decoupled MM memory systems, DRAM devices can operate at a relatively-low frequency, which saves memory power and energy. Memory power is reduced because the required electrical current to drive DRAM devices decreases with the data rate. In particular, the energy spent on background, I/O, and activations/precharges drops significantly in exemplary decoupled MM memory systems compared to conventional memory systems. Experimental results show that, when compared with a conventional memory system with a faster data rate, the power reduction and energy saving from the devices are larger than the extra power and energy consumed by a synchronization device of an exemplary memory system.

(3) Reliability. In general, DRAM devices with higher data rates are less reliable. In particular, various tests indicate that increasing the data rate of DDR3 devices by increasing their operation voltage beyond the suggested 1.5V causes memory data errors. As the exemplary decoupled MM design allows DRAM devices to operate at a relatively slow speed, exemplary decoupled MM memory systems have improved reliability.

(4) Cost Effectiveness. Generally, DRAM devices operating at higher data rates are more expensive. Exemplary decoupled MM memory systems are cost effective by permitting use of relatively-slower DRAM devices while maintaining relatively-fast channel bus data rates.

(5) Device Density. Exemplary decoupled MM designs allow the use of high-density and low-cost devices (e.g., DDR3-1066 devices) to build a high-bandwidth memory system. By contrast, conventional high-bandwidth memory systems currently use low-density and high-cost devices (e.g., DDR3-1600 devices).

(6) Module Count per Channel. The synchronization device in decoupled MM hides the devices inside the ranks from the memory controller, providing smaller electrical load for the controller to drive. This in turn makes it possible to mount more memory modules in a single channel than with conventional memory systems.

In other scenarios, decoupled MM memory systems provide virtually the same overall bandwidth using fewer channels than conventional memory systems. The use of fewer channels reduces the cost of circuit boards using the decoupled MM memory system and also reduces processor pin count.

An Exemplary Decoupled MM Memory System

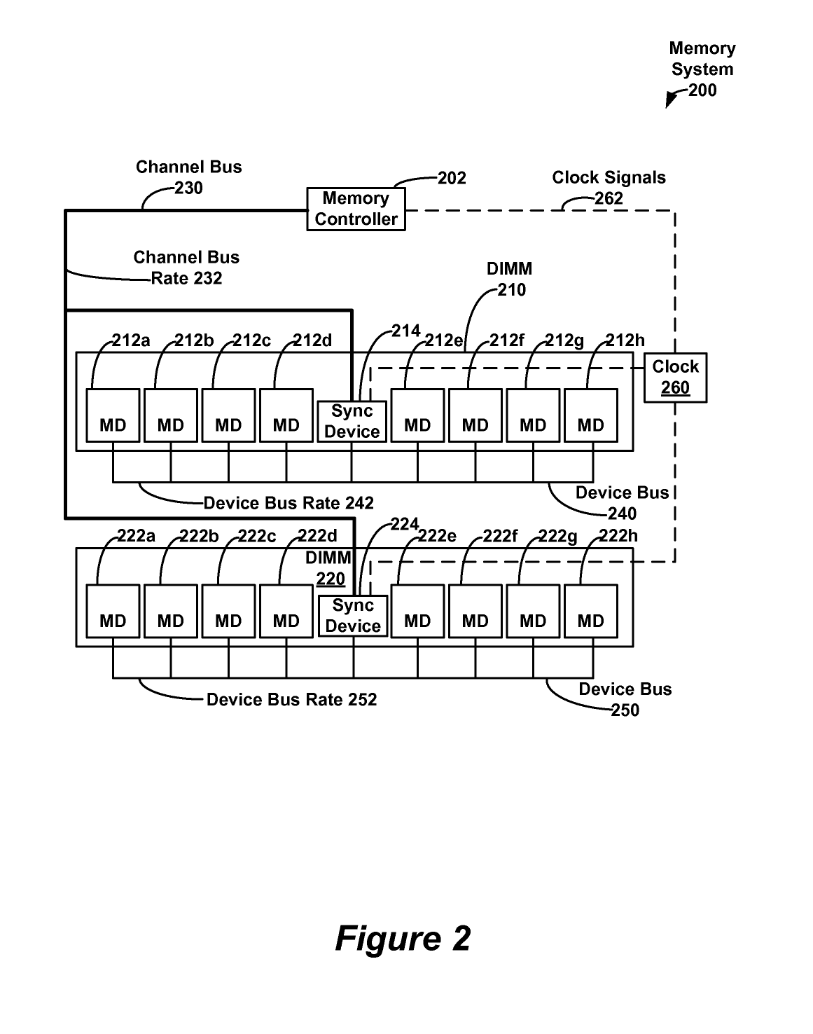

FIG. 2 is a block diagram of an exemplary memory system 200 with memory controller 202 connected to a memory channel with memory modules (MM) 210, 220 via channel bus 230 and clocked via clock device 260. Exemplary memory modules for use with the decoupled MM design include, but are not limited to, DIMMs, SIMMs, and/or Small Outline DIMMs (SO-DIMMs).

Memory controller 202 is configured to determine operation timing for memory system 200, i.e. precharge, activation, row/column accesses, and read or write operations, and the data bus usage for read/write requests. Further, memory controller 202 is configured to track the status of all memory ranks and banks, avoid bus usage conflicts, and maintain timing constraints to ensure memory correctness for memory system 200.

Each memory module 210, 220 has a number of memory devices (MDs) configured to store an amount of data and transfer a number of bits per operation (e.g., read operation or write operation) over a device bus. For example, memory module 210 is shown with 8 memory devices 212a-212h, each configured to store 1 Gigabit (Gb) and transfer 8 bits per operation via device bus 250. In this example, memory device 212a is termed an “8-bit” memory device. Continuing the example, assuming each of memory devices 212a-212h is a 8-bit memory device, memory module 210 is configured to transfer 64 bits per operation via device bus 250. Of course, other architectural structures can also be used.

In other embodiments, for example, each memory module 210, 220 can have more or fewer memory devices configured to transfer more or fewer bits per operation (e.g., 2, 4, or 8 16-bit memory devices, 4 or 16 8-bit memory devices, or 4, 8, or 16 4-bit memory devices) and each memory device may store more or less data than the 1 Gb indicated in the example above. Other configurations of memory devices beyond these examples can also be used.

Further, in embodiments not shown in FIG. 2, memory system 200 has either one memory module or more than two memory modules, and/or has more than one memory channel, perhaps using multiple memory controllers. In still other embodiments not shown in FIG. 2, memory system 200 has more than one channel.

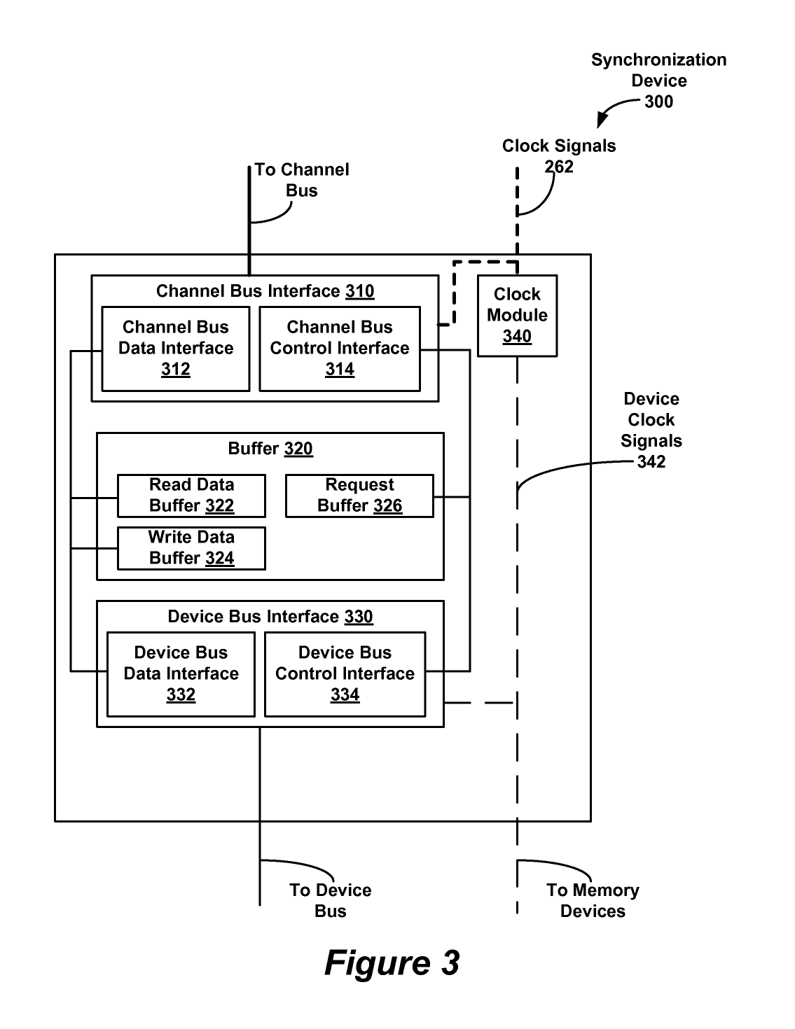

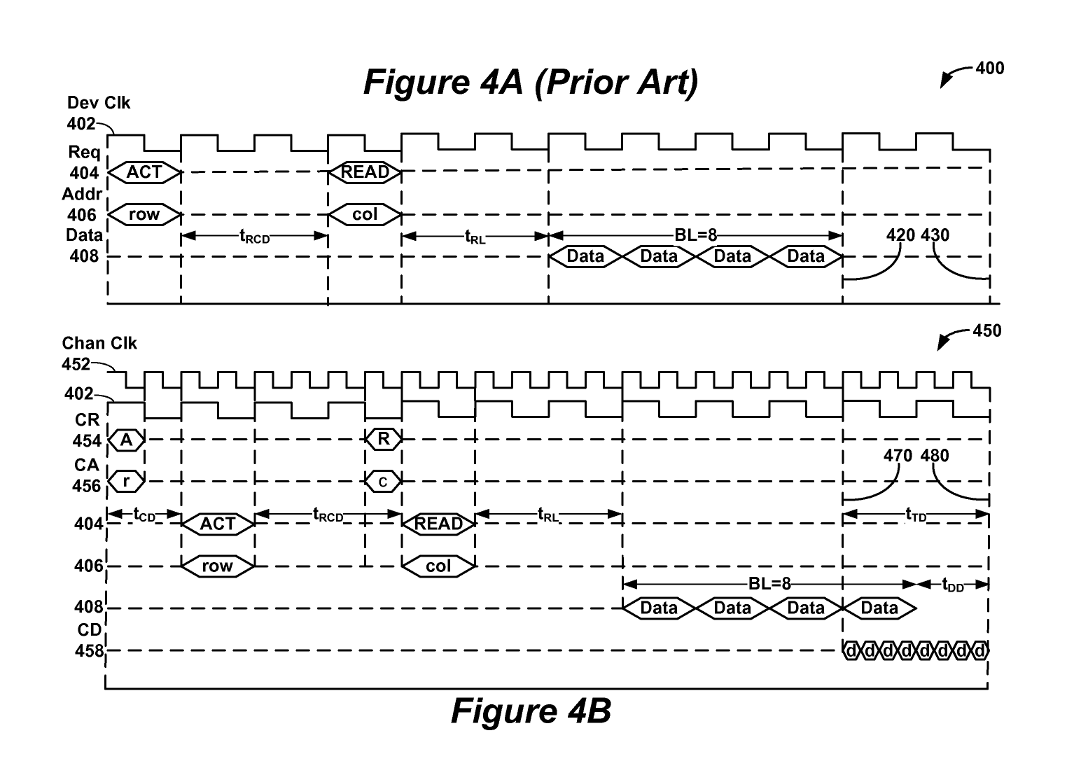

FIG. 2 shows each memory module 210, 220 configured with a respective synchronization device 214, 224. Synchronization devices 214, 224 are each configured to buffer data from memory devices (for read requests) or from memory controller 202 (for write requests). The buffered data are subsequently relayed to memory controller 202 (for read requests) or memory devices (for write requests). Thus, each synchronization device 214, 224 is configured to relay data between channel bus 230 at channel bus data rate 232 and memory devices connected to respective device buses 240, 250 at a respective device bus data rate 242, 252. Additional details of a synchronization device are discussed below in the context of FIG. 3, and operation timing of synchronization devices is explained below in more detail in the context of FIGS. 4A and 4B. While FIG. 2 shows synchronization devices 214, 224 on a respective memory module 210, 220, in some embodiments a synchronization device is configured as a stand-alone device and/or as part of another device (e.g., memory controller 202).

The channel bus 230 and/or device buses 240, 250 can be configured to transfer one or more bits of data substantially simultaneously. In some embodiments, the channel bus 230 and/or device buses 240, 250 are configured with one or more conductors of data that allow signals to be transferred between one or more components. Physically, these conductors of data can include one or more wires, fibers, printed circuits, and/or other components configured to transfer one or more bits of data substantially simultaneously between components.

As such, the channel bus 230 and/or device buses 240, 250 can each be configured with a “width” or ability to communicate a number of bits of information substantially simultaneously. For example, a 96-bit wide channel bus 230 could communicate 96 bits of information between memory controller 202 and synchronization device 214 substantially simultaneously. Similarly, an example 96-bit wide device bus 240 could communicate 96 bits of information between synchronization device 214 and memory devices 212a-212h substantially simultaneously. The data rate DR of a bus (e.g., channel bus 230 and/or device buses 240, 250) can be determined by taking a clock rate C of a bus and multiplying it by a width W of the bus. For an example 96-bit wide bus operating at 1000 MT/s, C=1000 MT/s, W=96 bits/transfer, and so DR=C*W=96,000 Mb/s or 96 Gb/s.

The channel bus 230 and/or device buses 240, 250 can be configured as logically or physically separate data and control buses. The data and control buses can have the same width or different widths. For example, in different embodiments, an example 96-bit wide channel bus 230 can be configured as a 48-bit wide control bus and 48-bit wide data bus (i.e., with data and control buses of the same width) or as a 32-bit wide control bus and 64-bit wide data bus (i.e., with data and control buses of different widths).

Clock 260 is configured to generate clock signals 262. In some embodiments, clock signals are a series of clock pulses oscillating at channel bus data rate 232. In these embodiments, clock signals 262 can be used to synchronize at least part of memory system 200 at channel bus data rate 232.

Channel bus data rate 232 is advantageously higher than device bus data rates 242, 252. As such, synchronization devices 214, 224 permit respective memory devices 212a-212h, 222a-222h to appear to memory controller 202 as operable at the relatively-high channel bus data rate 232.

In some embodiments, all memory module 210, 220 and corresponding device bus data rates 242, 252 of memory system 200 have the same numbers of ranks, the same numbers and types of memory devices, and operate each device bus at the same device bus data rate. In still other embodiments, some or all memory modules 210, 220 in memory system 200 vary in total storage capacity, numbers of memory devices, ranks, and/or bus rates.

The ratio R of channel bus data rate 232 m to a device bus data rate n (either device bus data rate 242 or 252) is advantageously greater than one. In an exemplary embodiment, channel bus data rate 232 is 1600 MT/s and device bus data rates 242, 252 are each 800 MT/s. For this exemplary embodiment, m is 1600 MT/s, n is 800 MT/s, and ratio R is two. When the ratio R is two, the synchronization device can use a frequency divider to generate the clock signal to the devices from the channel clock signal, as described in more detail below in the context of FIG. 3, while minimizing the synchronization overhead of separate channel bus and device bus clocks.

Further, a ratio R of two is also the ratio between the current memory devices and the projected channel bandwidth for the next generation DDRx devices. In particular, commonly available conventional memory devices have data rates of 1066 MT/s and 1333 MT/s, while data rates of 2133 MT/s and 2667 MT/s are projected in next generation for DDRx memories. In other embodiments, R is greater than one but less than two or greater than two (e.g., embodiments with more than two device buses per channel bus).

While FIG. 2 shows one synchronization device per memory module, in other embodiments one memory module can have multiple synchronization devices. In some embodiments, each synchronization device 214, 224 is configured to support one rank, while in other embodiments each synchronization device 214, 224 is configured to support multiple ranks Additional details of synchronization devices 214, 224 are discussed below in the context of FIG. 3.

For example, two (or more) synchronization devices can be used for memory modules with multiple ranks On multiple-rank memory modules, all ranks can be configured to be connected to a single synchronization device through a device bus, or the ranks of the memory module can be configured as two (or more) groups, each group connecting to a synchronization device. Using two or more synchronization devices can enable a single memory module to match the channel bus bandwidth when the device bus data rate is at least half of the channel bus data rate.

An Exemplary Synchronization Device

FIG. 3 is a block diagram of an exemplary synchronization device 300 with channel bus interface 310, buffer 320, device bus interface 330, and clock module 340. Channel bus interface 310 includes channel bus data interface 312 and channel bus control interface 314 to respectively transfer data and memory requests between channel bus interface 310 and a channel bus (e.g., channel bus 230 of FIG. 2).

In some embodiments, some or all of channel bus interface 310, channel bus data interface 312, and channel bus control interface 314 are parallel bus interfaces configured to send and receive a number of bits of data (e.g., 64 or 96 bits) substantially simultaneously. In other embodiments, channel bus data interface 312 is configured to provide the same number of bits substantially simultaneously as channel bus control interface 314 (i.e., has the same width), while in still other embodiments, channel bus data interface 312 is configured to provide a different number of bits substantially simultaneously as channel bus control interface 314 (i.e., have different widths). In some scenarios, some or all of channel bus interface 310, channel bus data interface 312, and channel bus control interface 314 comply with existing DDRx memory standards, and as such, can communicate with DDRx memory devices.

Similarly, device bus interface 330 includes device bus data interface 332 and device bus control interface 334 to respectively transfer data and requests between device bus interface 330 and a device bus (e.g., device bus 240 or 250 of FIG. 2).

In some embodiments, some or all of device bus interface 330, device bus data interface 332, and device bus control interface 334 are parallel bus interfaces configured to send and receive a number of bits of data (e.g., 64 bits, 96 bits) substantially simultaneously. In other embodiments, device bus data interface 332 is configured to provide the same number of bits substantially simultaneously as device bus control interface 334 (i.e., have the same width), while in still other embodiments, device bus data interface 332 is configured to provide a different number of bits substantially simultaneously as device bus control interface 334 (i.e., have the different widths). In yet other embodiments, widths of channel bus data interface 312 and device bus data interface 332 are the same and/or widths of channel bus control interface 314 and device bus control interface 334 are the same. In some scenarios, some or all of device bus interface 330, device bus data interface 332, and device bus control interface 334 comply with existing DDRx memory standards, and as such, can communicate with DDRx memory devices.

Buffer 320 includes read data buffer 322, write data buffer 324, and request buffer 326. Channel bus interface 310 can be configured to use clock signals 362 to transfer information between buffer 320 and the channel bus at a clock rate of the clock signals 362. In some embodiments, clock signals 362 are generated at the same rate as clock signals 262 of FIG. 2.

Read data buffer 322 includes sufficient storage to hold data related to one or more memory requests to read data from memory devices accessible on a device bus. Write data buffer 324 includes sufficient storage to hold data related to one or more memory requests to write data to memory devices accessible on the device bus. In some embodiments, read data buffer 322 and write data buffer 324 can transfer 64 bits of data at once into or out of a respective buffer (i.e., are 64 bits wide); but in other embodiments, read data buffer 322 and write data buffer 324 can transfer more or fewer than 64 bits at once (e.g., 32-bit wide or 128-bit wide buffers). In other embodiments, read data buffer 322, write data buffer 324, and/or request buffer 326 are combined into a common buffer.

Request buffer 326 includes sufficient storage to hold one or more memory requests for memory devices accessible on the device bus. For example, the request buffer can hold bank address bits, row/column addressing data, and information regarding various signals, such as but not limited to: RAS (Row Address Strobe), CAS (Column Address Strobe), WE (Write Enable), CKE (ClocK Enable), ODT (On Die Termination) and CS (Chip Select). In some embodiments, request buffer 326 is 32 bits wide, but in other embodiments request buffer 326 transfers more or fewer than 32 bits at once (i.e., is wider or narrower than 32 bits).

To process a memory request to read “read data” from memory device(s) on the device bus, a read memory request is first received at channel bus control interface 314 of channel bus interface 310 from the channel bus. In some embodiments, the read memory request is stored (buffered) in request buffer 326. The read memory request is sent to the memory device(s) via device bus control interface 334 of device bus interface 330 and then on to the device bus. Once the requested data has been read from the memory device(s), the requested data are placed on the device bus and received at device bus interface 332 of device bus interface 330. In some embodiments, the requested data are stored in read data buffer 322. The requested data are then passed, either directly from device bus interface 332 or read data buffer 322, to the channel bus data interface 312 of channel bus interface, and then onto the channel bus.

To process a memory request to write “write data” to the memory device(s) on the device bus, a write memory request is first received at channel bus control interface 314 of channel bus interface 310 from the channel bus. The write data arrives at channel bus data interface 312 of channel bus interface 310. In some embodiments, the write memory request is stored in request buffer 326. The write memory request sent to memory device(s) via device bus control interface 334 of device bus interface 330 and then on to the device bus. The write data are sent to the memory device(s) via device bus data interface 332 of device bus interface 330 and then on to the device bus. Upon arrival at the memory device(s), the write data are written to the memory device(s).

In some embodiments, a memory controller is configured to schedule memory requests while accounting for operation of synchronization device 300. Memory access scheduling for synchronization device 300 includes provision for two levels of buses—the channel bus and device bus(es)—connected to synchronization device 300.

In some embodiments, a memory controller can schedule memory requests and accesses by treating all ranks of memory module(s) in a memory channel as if all ranks were directly attached to the channel bus operating at the (higher) channel bus data rate. The memory controller can then schedule memory requests to enforce all timing constraints adjusted to the channel bus data rate, and account for any synchronization device delay. The memory controller can further enforce an extra timing constraint to separate any two consecutive requests sent to memory ranks sharing the same device bus. By scheduling according to the channel bus data rate and enforcing the extra timing constraint, the memory controller can avoid access conflicts on all device buses as long as there are no access conflicts on the channel bus.

In other embodiments, an incoming data burst (memory request and data) can be pipelined with the corresponding outgoing data burst. Thus, the last potion of the outgoing burst can complete one device bus cycle later than the last chunk of the incoming burst. The memory controller can be configured to ensure timing constraints of each rank, and thus ensure access conflicts do not occur for pipelined memory requests/data bursts.

Clock module 340 includes one or more circuits configured to provide clock signals to operate the synchronization device, by converting clock signals 362 used to clock the channel bus into slower device clock signals 342. The memory device(s) attached to the device bus can then use the slower device clock signals 342 for clocking. Device bus interface 330 can be configured to use the device clock cycles 342 to transfer information between buffer 320 and the memory device(s) attached to the device bus at a clock rate of the device clock signals 342.

The clock module 340 can use a frequency divider with shift registers to convert clock signals 362 to device clock signals 342 when the ratio R of channel bus data rate m to a device bus data rate n is an integer. When the ratio R is not an integer, PLL (Phase Lock Loop) or similar logic can be used to convert clock signals 362 to device clock signals 342. In some embodiments, clock module includes both frequency divider(s) and PLL logic. In still other embodiments, clock module 340 is separate from synchronization device 300. In even other embodiments, the clock module 340 can include delayed loop logic (DLL) or similar logic to reduce the clock skew between the channel bus and the device bus(es).

Clock signals 362 can be generated by an external clock source, such as a real-time clock circuit, clock generator, and/or other similar circuit configured to provide a series of clock pulses. In embodiments not shown in FIG. 3, device clock signals 342 can be generated by an external clock source, such as a real-time clock circuit, a clock generator, and/or other similar circuit configured to provide a series of clock pulses—in such scenarios, an external clock source for clock signals 362 can provide device clock signals 342, while in similar scenarios, two separate external clock sources provide clock signals 362 and device clock signals 342.

Timing Diagrams of Conventional and Exemplary Memory Systems

FIG. 4A is a timing diagram 400 of a conventional memory system and FIG. 4B is a timing diagram 450 of an exemplary memory system. In particular, FIG. 4A shows the scheduling results of a conventional DDR3 system and FIG. 4B shows scheduling results for a decoupled MM memory system with a ratio R of 2 between channel bus data rate and device bus data rate.

Timing diagrams 400 and 450 show timing for a single read request to a precharged rank. The request is transformed to two DRAM operations, an activation (row access), and a data read (column access). Timing diagrams for write requests (not shown in FIG. 4A or 4B) for conventional and exemplary memory systems would be similar to those shown in respective FIGS. 4A and 4B.

FIG. 4A depicts a timing diagram 400 for a conventional memory system clocked using device clock (“Dev Clk”) 402 to service memory requests (“Req”) 404 using addresses (“Addr”) 406 to transfer data 408. In the example shown in FIG. 4A, during the first device clock cycle, an activation memory request “ACT” is received along with a row address “row.” FIG. 4A shows that the conventional memory system takes t_{RCD}, or two device clock cycles, to activate the memory and await a follow-on memory request. After t_{RCD} has elapsed, FIG. 4A shows that a read request “READ” and a column address “col” are received at the conventional memory system. The memory devices of the conventional memory system incur a request latency of t_{RL}, or two device cycles, to retrieve the requested read data as addressed by the row/col pair of addresses.

Once the requested read data are available, FIG. 4A shows that the memory devices provide the read data “Data” over four device clock cycles. In the example shown in FIG. 4A, the read data are 8 bytes long (BL=8 in FIG. 4A). As shown by finish line 420 of FIG. 4A, the activation and read requests take a conventional memory system ten memory cycles to complete.

FIG. 4B depicts a timing diagram 450 for an exemplary memory system clocked using device clock 402 and channel clock (“Chan Clk”) 452 to service device bus requests 404 and channel bus requests (“CR”) 454 using device bus addresses 406 and channel bus addresses (“CA”) 458 to transfer device bus data 408 and channel bus data (“CD”) 458. The example memory operations shown in FIG. 4A—activate and read requests—are also shown in FIG. 4B.

In the example shown in FIG. 4B, during the first channel clock cycle, the exemplary memory system receives an activation request “A” and row address “r” at a synchronization device via a channel bus. The exemplary memory incurs t_{CD}, or time for request delay, while waiting for the next leading edge of device clock 402. Then, during the second device clock signal, the synchronization device provides activation request “ACT” and row address “row,” corresponding to activation request “A” and row address “r” respectively, to memory device(s) of the exemplary memory system via a device bus.

As with the conventional memory, FIG. 4B shows the exemplary memory system takes t_{RCD}, or two device clock cycles, to activate the memory device(s) and await a follow-on memory request. As shown in FIG. 4B, the exemplary memory system receives read request “R” and column address “c” at the synchronization device via the channel bus during the t_{RCD} interval. FIG. 4B depicts that once the t_{RCD} interval has expired, the synchronization device provides read request “READ” and column address “col”, corresponding to read request “R” and column address “col” respectively, to the memory device(s) of the exemplary memory system via the device bus. The memory devices of the exemplary memory system, like those of the conventional memory system, incur a request latency of t_{CL} or two device cycles to retrieve the requested read data addressed by the row/col pair.

FIG. 4B shows that, once the requested read data are available, the memory devices provide the read data “Data” to the synchronization device via the device bus over four device clock cycles. In the example shown in FIG. 4B, the read data are eight bytes long (BL=8 in FIG. 4B), which is the same size as the read data of FIG. 4B. FIG. 4B also shows that once three-fourths of the read data are available at the synchronization device, the synchronization device begins to put the read data “d”, corresponding to read data “Data”, on the channel bus. The synchronization device takes eight channel clock cycles to transfer the read data onto the channel bus. As also shown in FIG. 4B, the synchronization device simultaneously receives data from the memory device(s) and puts data on the channel bus.

As shown at finish line 480 of FIG. 4B, the activation and read requests take twelve memory cycles for the exemplary memory system complete. To aid comparison, FIG. 4B includes line 470 indicating ten device cycles of the exemplary memory system, which corresponds to finish line 420 of FIG. 4A.

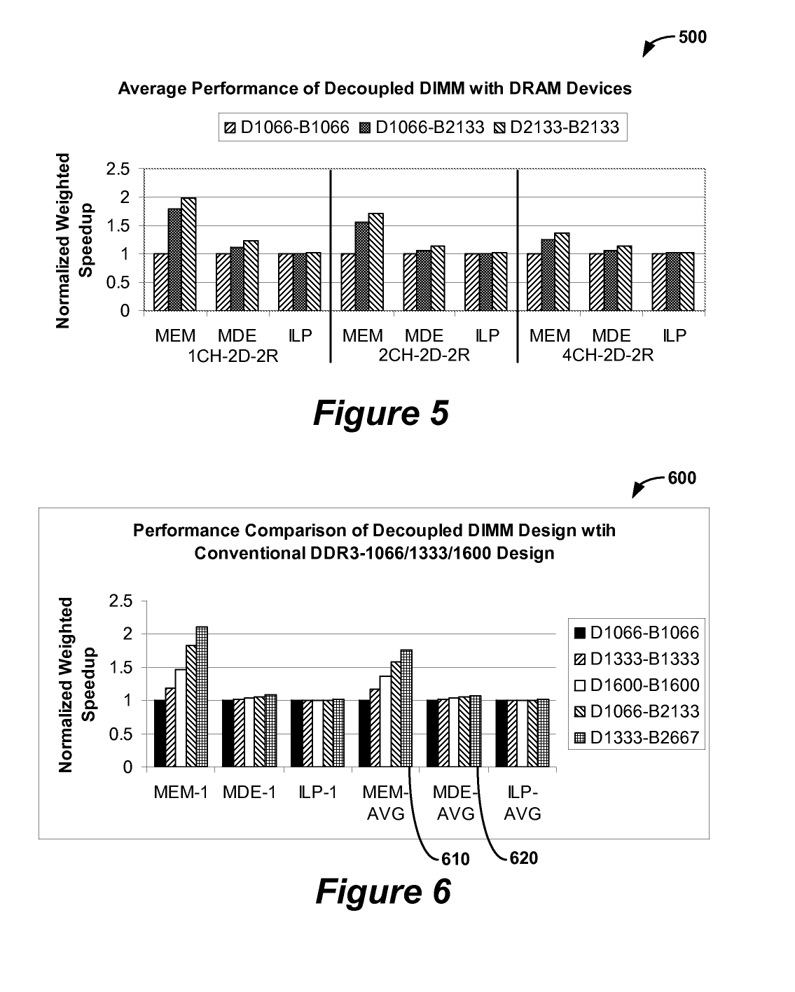

When compared with the conventional system, the synchronization device of decoupled MM increases memory idle latency by two device clock cycles total (t_{TD} as shown in FIG. 4B): one cycle (t_{CD} of FIG. 4B) to relay the memory request and address and another cycle (t_{DD} of FIG. 4B) for relaying the data. However, in practice, there are multiple memory requests pending simultaneously. The exemplary memory system can process these multiple simultaneous memory requests faster than conventional memory systems because the channel bus operates at a higher frequency than the device buses, and the channel and devices buses can operate in parallel. FIGS. 5, 6, 7, 8, 9, 10, 11A, and 11B provide detailed comparisons between various conventional memory systems and embodiments of the exemplary memory system that indicate the overall penalty for use of a synchronization device is relatively small.

Power Modeling

The synchronization device was modeled using the Verilog hardware description language. The model for the synchronization device included four portions, including: (1) the device bus input/output (I/O) interface to the memory devices, (2) the channel bus I/O interface to the channel bus, (3) clock module logic, and (4) non-I/O logic including memory device data entries, request/address buffers and request/address relay logic. The model indicates power consumption of the synchronization device is relatively small and is more than offset by the power saving from DRAM devices. The model assumed use of well-known implementations of I/O, DRAM read, and DRAM write circuits.

Table 3 below shows power usage for the synchronization device as estimated by the model.

TABLE 3

| Synchronization Device Component | Power |
|---|---|
| Channel I/O Interface | 1157 mW |
| Device Bus I/O interfaces | 482 mW |
| Clock Module Logic | 95 mW |
| Non-I/O Logic | 102 mW |
| Total Power | 1836 mW |

Memory Simulation and Results

Overall, memory simulation results indicated the exemplary memory system was more power-efficient and saved memory energy while processing memory-intensive workloads and did not require more energy in processing moderate or processor-intensive workloads.

In particular, the exemplary memory device permits use of relatively-slow memory device(s) while maintaining a relatively-high channel bus data rate. As explained above, relatively-slow memory devices typically require less power than relatively-fast memory devices. Thus, by using relatively-slow memory devices, power consumption for exemplary memory systems can be reduced. Further, the memory simulation results indicate that the exemplary memory system using a ratio R of 2 provides a 2-to-1 speedup on memory intensive benchmark tests.

The M5 simulator was used as a base architectural simulator with extensions to simulate the both conventional memory system and the exemplary memory system. The simulator tracked the states of each memory channel, memory module, rank and bank. Based on the current memory state, memory requests were issued by M5 according to the hit-first policy, under which row buffer hits are scheduled before row buffer misses. Read operations were scheduled before write operations under normal conditions. However, when pending write operations occupied more than half of a memory buffer, writes were scheduled first until they occupy no more than one-fourth of the memory buffer. The memory transactions were pipelined whenever possible. XOR-based address mapping was used as the default configuration. The simulation results assumed each processor core is single-threaded and ran a distinct application.

Table 4 shows components, parameters, and values used in the simulation.

TABLE 4

| Simulation Component | Parameter and Values |
|---|---|
| Processors | 4 cores, 3.2 GHz, 4 issues per core, 16 stage pipelines |
| Functional units | 4 integer arithmetic logic units (ALUs), 2 Integer |
| | multipliers, 2 floating point ALUs, 1 floating point |
| | multiplier |
| Issue Queue (IQ), Reorder Buffer | IQ - 64 entries, ROB - 196 entries, Load Queue and Store |
| (ROB), and Load/Store Queue | Queue - 32 entries each |
| (LSQ) sizes | |
| Branch Predictor | Hybrid, 8K global + 2K global, 16 entry RAS, 4 way |
| | Branch Transfer Buffer (BTB) |
| Level 1 Caches (per core) | 64 KB instruction cache, 64 KB data cache, 2-way, 64-bit |
| | lines, hit latency of 1 cycle instructions/3 cycles data |
| Level 2 Caches (shared) | 4 MB, 4-way, 64-bit lines, 15-cycle bit latency |
| Miss Status Holding Register | Instructions - 8, Data - 32, Level2 cache - 64 |
| entries | |
| Memory | 1, 2, and 4 channels, each channel with 2 DIMMs/channel, |
| | 2 ranks/DIMM, 8 banks/rank, 9 memory devices/rank |
| Memory Controller | 64 entry buffer, 15 ns overhead |
| DDR3 Channel bandwidth | 8 bytes/channel. Specific bandwidths used: 800MT/s (6.4 GB/s), |
| | 1066 MT/s (8.5 GB/s), 1333 MT/s (10.6 GB/s), and |
| | 1600 MT/s (12.8 GB/s). |
| DDR3 DRAM Latency | DDR3-800: 6-6-6 |
| Parameters (CAS-t_{RCD}-t_{RP}) | DDR3-1066: 8-8-8 |
| | DDR3-1333: 10-10-10, precharge/row access/column |
| | access = 15 ns |
| | DDR3-1600: 11-11-11, precharge/row access/column |
| | access = 13.75 ns |
| | DDRx-2133: 14-14-14 |

The power consumption of DDR3 DRAM devices was estimated using the Micron power calculation methodology, where a memory rank is the smallest power unit. At the end of each memory cycle, the simulator checked each rank state and calculated the energy consumed during the cycle accordingly. The parameters used to calculate the DRAM (with 1 Gb 8-bit devices) power and energy are listed in Table 2 above. Current values presented in manufacturers' data-sheets that exceed maximum device voltage are de-rated by the normal voltage.

The memory simulator used 8-bit DRAM devices with cache line interleaving and close page mode and auto precharge. The memory simulator used a power management policy of putting a memory rank into a low power mode when there is no pending request to the memory rank for 24 processor cycles (7.5 ns). The default low power mode was “precharge power-down slow” that consumed 128 mW per device with 11.25 ns exit latency. Simulation results indicated this default low power mode had a better power/performance trade-off when compared with other low power modes.

The SPEC2000 suite of benchmark applications was used as workloads by the memory simulator. The benchmark workloads of the SPEC2000 suite are grouped herein into MEM (memory intensive), MDE (moderate), and ILP (compute-intensive) workloads based on their memory bandwidth usage level. MEM workloads had memory bandwidth usages higher than 10 GB/s when four instances of the application were run on a quad-core processor with a four-channel DDR3-1066 memory system. ILP workloads had memory bandwidth usages lower than 2 GB/s; and the MDE workloads had memory bandwidth usages between 2 GB/s and 10 GB/s.

In order to limit the simulation time while still emulating the representative behavior of program executions, a representative simulation point of 100 million instructions was selected for every benchmark according to SimPoint 3.0.

A normalized weighted speedup metric is shown in FIGS. 5, 6, 10, 11A, and 11B. For each of these Figures, a weighted speedup first was calculated. The weighted speedup S was calculated using Equation (1) below:

$$S = {\sum }_{i = 1}^{n} \frac{I P {C}_{multi} [ i ]}{I P {C}_{single} [ i ]} \qquad ( 1 )$$

where: n is the total number of cores,

IPCₘᵤₗₜᵢ[i] is the number of instructions per cycle (IPC) for an application running on the i^{th} core under multi-core execution, and

IPC_{single}[i] is the IPC for an application running on the i^{th} core under single-core execution. The weighted speedup was then normalized as discussed below.

The nomenclature “Ddbdr−Bcbdr” used below describes a memory system with a device bus data rate of dbdr MT/s and channel bus data rate of cbdr MT/s. If dbdr=cbdr, the memory system is a conventional memory system, while the condition cbdr>dbdr indicates the memory system an exemplary decoupled MM memory system. As examples, a “D1066-B 1066” memory system is a conventional memory system with both a device bus data rate and a channel bus data rate of 1066 MT/s, and a “D1066-B2133” memory system is an exemplary memory system with a device bus data rate of 1066 MT/s and a channel bus data rate of 2133 MT/s (thus having a ratio R of 2).

The nomenclature “xCH-yD-zR” used below represents a memory system with x channels, y memory modules per channel and z ranks per memory module. For example, a “4CH-2D-2R” memory system has four DDR3 channels, two memory modules per channel, two ranks per memory module, and nine devices per rank (with error correction codes).

Overall Performance of Decoupled MM Memory Systems

FIG. 5 depicts a performance comparison 500 of two conventional memory systems (D1066-B1066 and D2133-B2133) with an exemplary memory system (D1066-B2133). The weighted speedups in performance comparison 500 were normalized to speedups of the D1066-B1066 conventional memory system. Performance comparison 500 shows results for three channel configurations: 1CH-2D-2R, 2CH-2D-2R and 4CH-2D-2R, with single channel, two channels and four channels, respectively; each channel has two memory modules and each memory module has two ranks.

FIG. 5 shows use of the exemplary D1066-B2133 memory system significantly improves the performance of the MEM and MDE workloads over the conventional D1066-B1066 memory system. Both the exemplary D1066-B2133 memory system and the conventional D1066-B1066 memory system both use memory devices operating at 1066 MT/s.

Performance comparison 500 shows the exemplary D1066-B2133 memory system with an average 79% performance gain over the conventional D1066-B1066 memory system in single-channel configurations, an average 55% performance gain in dual-channel configurations, and an average 25% performance gain in four-channel configurations, respectively, for MEM workloads.

MDE workloads demand less memory bandwidth than MEM workloads. Even so, MDE workloads benefit from the increase in channel bandwidth provided by the exemplary D1066-B2133 memory system. FIG. 5 shows the average performance gain by the D1066-B2133 over the conventional D1066-B1006 memory system is 12%, 5%, and 5% (up to 6.6%) for single, dual, and four-channel configurations, respectively.

The performance gain with four-channel configurations was lower because only four-core processors were simulated. With a four-channel configuration for four cores, memory bandwidth was less a performance bottleneck, and thus less performance gain was observed. Modern four-core processor systems typically use two memory channels, and thus performance gains such as the 55% dual-channel performance gain shown in FIG. 5 could be expected in modern four-core systems. Also, four-channel configurations are expected to run with processors of more than four cores.

Compared with the conventional D2133-B2133 memory system, the exemplary D1066-B2133 memory system used memory devices that operate at half the speed of the conventional D2133-B2133 system. Nevertheless, the performance of the exemplary D1066-B2133 memory system almost reached the performance of the conventional D2133-B2133. FIG. 5 shows an average performance difference of the exemplary D1066-B2133 memory system and the conventional D2133-B2133 memory system of 10%, 9.4% and 8.1% for MEM workloads, and 8.9%, 7.9% and 7.1% for MDE workloads, on single-, dual-, and four-channel configurations, respectively.

Design Trade-Off Comparisons

FIG. 6 depicts another performance comparison 600 of exemplary memory systems with conventional memory systems.

Performance comparison 600 compares the performance of two exemplary memory systems, D1066-B2133 and D1333-B2667, with three conventional memory systems of different rates, D1066-B1006, D1333-B1333, and D1600-B1600. All memory systems compared in performance comparison 600 have dual-channel 2CH-2D-2R memory configurations (with two ranks per memory module and two memory modules per channel) as the base configuration. The weighted speedups in performance comparison 600 were normalized to speedups of the D1066-B1066 conventional memory system.

As indicated by MEM-AVG figures 610 of performance comparison 600, the exemplary D1066-B2133 memory system improved the performance of the MEM workloads by 57.9% on average over the conventional D1066-B1066 system, due to the higher channel bus bandwidth of the exemplary memory system. Recall, though, that the exemplary D1066-B2133 memory system and conventional D1066-B1066 memory system both used memory devices operating at 1066 MT/s.

The exemplary D1066-B2133 memory system improved the performance of MEM workloads compared with the two conventional D1333-B1333 and D1600-B1600 memory systems, which used faster memory devices but slower channel buses. FIG. 6 indicates that the exemplary D1066-B2133 memory system outperforms the conventional D1333-B1333 and D1600-B1600 memory systems by 36.1% and 15.0% on average, respectively. Performance comparison 600 demonstrates that channel bus bandwidth is crucial to overall performance and thus, the exemplary memory system provides better performance than conventional memory systems using faster memory devices.

Similarly, FIG. 6 indicates that the faster exemplary decoupled MM D1333-B2667 system improved the performance of MEM workloads by 51.6% and 28.1% on average compared with the conventional D1333-B1333 and D1600-B1600 memory systems, respectively. As expected, the performance gain of decoupled MM on the MDE workloads was lower since MDE workloads have moderate demands on memory bandwidth. For instance, MDE-AVG figures 620 of performance comparison 600 indicate the average performance gain of D1333-B2667 over the conventional D1333-B1333 and D1600-B1600 memory systems for the MDE workloads is only 4.7% and 3.0%, respectively.

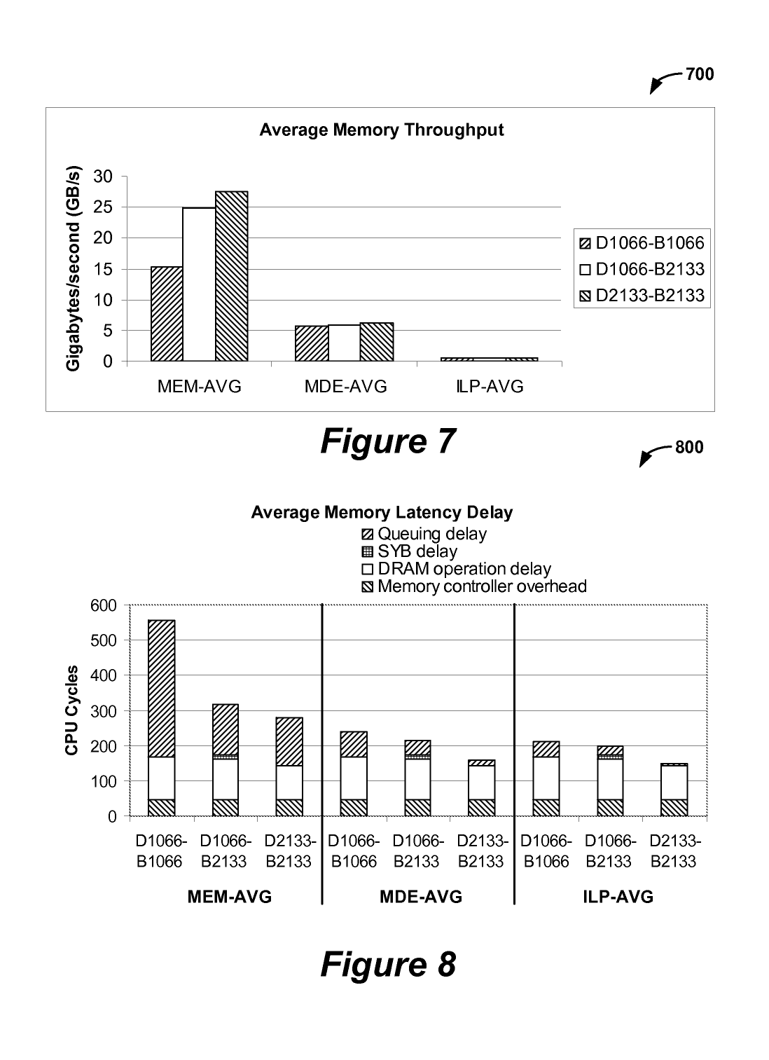

FIG. 7 depicts a memory throughput comparison 700 of an exemplary D1066-B2133 memory system with conventional D1066-B1066 and D2133-B2133 memory systems. FIG. 7 demonstrates that exemplary decoupled MM memory systems can improve performance significantly for MEM workloads by using high-bandwidth channels and low-bandwidth (also low-cost/low-power) devices.

Memory throughput comparison 700 shows throughput increases with channel bandwidth. In particular, memory throughput on MEM-AVG workloads increased 61.6% for the exemplary D1066-B2133 memory system compared with the conventional D1066-B1066 system. The significant portion of performance gain came from increased bandwidth and improved memory bank utilization; both of which were critical in processing memory-intensive workloads. Further, use of the exemplary D1066-B2133 memory system showed no negative performance impact on the MDE-AVG and ILP-AVG workloads.

FIG. 8 depicts a latency comparison 800 of an exemplary memory system with conventional memory systems. Latency comparison 800 used a 4-part division of latency for memory read operations: memory controller overhead, DRAM operation delay, additional latency introduced by the synchronization device (“SYB delay” as shown in FIG. 8) and queuing delay.

Memory controller overhead included a fixed latency of 15 ns (48 processor cycles). DRAM operation delay included memory idle latency, including DRAM activation, column access, and data burst times from memory devices under a closed page mode. According to DRAM device timing and PIN bandwidth configuration, DRAM operation delay was 120 and 96 processor cycles for the respective D1066-B1066 and D2133-B2133 memory devices. Latency introduced by the synchronization device was 12 processor cycles for the exemplary D1066-B2133 memory system and 0 processor cycles for the conventional memory systems.

Latency comparison 800 shows average read latency decreases as the channel bandwidth increases. The additional channel bandwidth provided by the exemplary D1066-B2133 significantly reduced the queuing delay. For instance, latency comparison 800 of FIG. 8 indicates that average queuing delay was reduced from 387 processor cycles for the conventional D1066-B1066 memory system to 142 processor cycles for the exemplary D1066-B2133 memory system. The queuing delay of 142 processor cycles for the exemplary D1066-B2133 memory system compared favorably with a queuing delay of 135 processor cycles for the conventional D2133-B2133 using memory devices that had twice the speed of memory devices used in the exemplary D1066-B2133 memory system.

The extra latency introduced by the synchronization device contributed only a small percentage of the total access latency, especially for the MEM workloads. Latency introduced by the synchronization device took up only 3.7% of the average MEM workload average for the exemplary D1066-B2133 memory system. For the MDE workloads, the queuing delay was less significant than for the MEM workloads. However, FIG. 8 indicates that the reduction of queuing delay for MDE workloads more than offset the additional latency from the synchronization device in the exemplary D1066-B2133 memory system. For the ILP workloads, while the latency introduced by the synchronization device was larger, the overall effect on performance was only 6.0%.

Power and Performance Comparisons of Exemplary and Conventional Systems

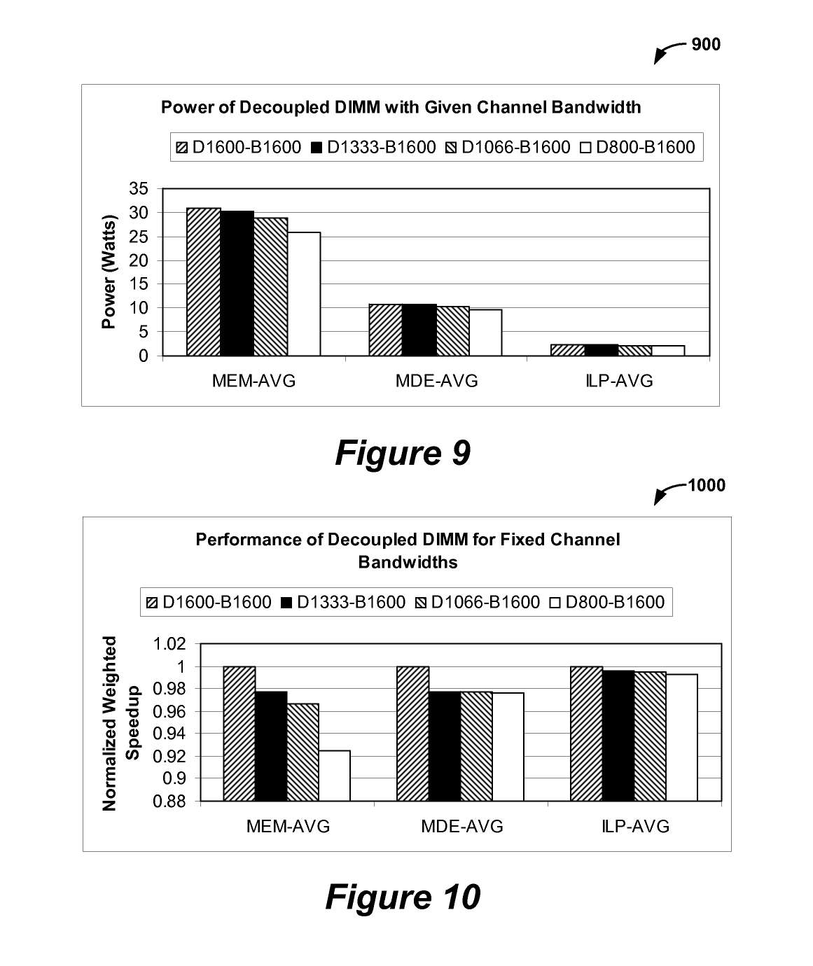

FIG. 9 depicts a power comparison 900 of exemplary memory systems with conventional memory systems. In particular, power comparison 900 compares the memory power consumption of exemplary D800-B1600, D1066-B1600, and D1333-B1600 memory systems using DDR3-800, DDR3-1066, DDR3-1333 and DDR3-1600 devices, respectively. Data for a conventional D1600-B1600 memory system are also included for comparison. These four memory systems all provided a channel bandwidth of 1600 MT/s.

Power comparison 900 demonstrates that any additional power consumption of exemplary systems is more than offset by power savings obtained by using slower memory devices, as the exemplary D800-B1600, D1066-B1600, and D1333-B1600 memory systems each consumed less power than the conventional D1600-B1600 memory system for the MEM-AVG, MDE-AVG, and ILP-AVG workloads.

As mentioned above, the exemplary decoupled MM architecture provides opportunities for saving power by enabling relatively-high-speed memory systems that use relatively-slow DRAM devices. Power consumption 900 accounted for five different types of power consumption:

(1) power consumed by non-I/O logic of a synchronization device and I/O operations between memory devices and the synchronization device. Conventional memory systems do not have any power by a synchronization device.

(2) power consumed for I/O operations between memory devices or the synchronization device and the device bus,

(3) power consumed by memory devices for read and write operations,

(4) device operation power, and

(5) device background power.

FIG. 9 demonstrates that, for a given channel bandwidth and memory-intensive workloads, memory power consumption generally decreased with the DRAM device data rate. As indicated in FIG. 9, the conventional D1600-B1600 memory system consumed 30.8 W for MEM-AVG workloads. In contrast, the memory power consumption of the exemplary D1333-B1600, D1066-B1600 and D800-B1600 memory system for the MEM-AVG work-loads was reduced by 1.6%, 6.7% and 15.9% to 30.3 W, 28.7 W and 25.8 W, respectively.

This power reduction stems from a reduction in current needed to drive DRAM devices at slower data rates (see Table 2). For example, current required for precharging (the “operating active-precharge” parameter of Table 2) is 90 mA for DDR3-800 devices used in the exemplary D800-B1600 memory system and 120 mA for DDR3-1600 devices used in the conventional D1600-B1600 memory system.

Further, background power, operation power, and read/write power consumption of modern memory devices all decreased as data rate decreased. Exemplary memory systems enjoyed substantial power savings by reducing operational power and background power. DRAM operation power used on a MEM-1 benchmark workload, for example, was reduced from 15.4 W in a conventional D1600-B1600 memory system to 13.2 W, 12.4 W and 10.6 W for exemplary D1333-B1600, D1066-B1600 and D800-B1600 memory systems, respectively.

The power consumed by the synchronization device is the sum of the first two types of memory power consumption listed above. However, only the first type of power consumption—power consumed by the synchronization device's non-I/O logic and its I/O operations with devices—is additional power consumed by exemplary memory systems compared to conventional memory systems. This type of power consumption decreases with DRAM device speed because of lower running frequency and less memory traffic passing through the synchronization device. For instance, the additional power used by a synchronization device to process the MEM-1 benchmark workload was 850 mW, 828 mW and 757 mW per memory module for the exemplary D1333-B1600, D1066-B1600 and D800-B1600 systems, respectively.

The second type of power consumption—power of I/O operations between the devices or synchronization device and DDRx bus—is required by both conventional memory systems and the exemplary decoupled MM memory systems. The second type of power consumption was consumed by the synchronization device in the exemplary memory systems and was consumed by memory devices in conventional memory systems. The overall power consumption of the synchronization device for the MEM-1 benchmark workload was 2.54 W, 2.51 W, and 2.32 W per memory module of the exemplary D1333-B1600, D1066-B1600, and D800-B1600 memory systems, respectively. Thus, only about one-third of the power consumed by the synchronization device was additional power consumption.

FIG. 10 depicts another performance comparison 1000 of exemplary memory systems with conventional memory systems. In particular, performance comparison 1000 compares the performance of exemplary D800-B1600, D1066-B1600, and D1333-B1600 configurations using DDR3-800, DDR3-1066, DDR3-1333, and DDR3-1600 devices, respectively. Data for a conventional D1600-B1600 memory system are also included for comparison. The weighted-speedups in performance comparison 1000 are normalized to the speedup of the conventional D1600-B1600 memory system. The four memory systems of performance comparison 1000 are the same memory systems used in power comparison 900 of FIG. 9. Recall that these four memory systems all provide a channel bandwidth of 1600 MT/s.

As the exemplary D800-B1600, D1066-B1600, and D1333-B1600 systems use slower memory devices (800 MT/s, 1066 MT/s, and 1333 MT/s, respectively) than the 1600 MT/s devices used in the conventional D1600-B1600 memory system, the conventional memory D1600-B1600 system should perform somewhat better than the exemplary systems. However, FIG. 10 demonstrates that the exemplary memory systems nearly equaled the performance of the conventional D1600-B1600 memory system.

Performance comparison 1000 shows that, compared with the conventional D1600-B1600 memory system, the exemplary D800-B1600 memory system had an average performance loss of 8.1% while using 800 MT/s memory devices that operated at one-half of the bandwidth of the 1600 MT/s memory devices in the conventional D1600-B1600 memory system. This relatively small performance difference is based on use of the same channel bus data rate of 1600 MT/s in both the exemplary D800-B1600 memory system and the conventional D1600-B1600 memory system.

Performance comparison 1000 also shows that, for fixed channel bus data rates of the exemplary memory systems, increasing device bus data rates from 800 MT/s to 1066 MT/s and 1333 MT/s helped reduce conflicts at the synchronization device. As mentioned above in the context of FIG. 9, the exemplary D800-B1600 memory system reduced the memory power consumption up to 15.9% for the MEM-AVG workloads while only incurring a performance loss of 8.1%. For MDE-AVG and ILP-AVG workloads, the average power savings for use of the exemplary D800-B1600 memory system compared to the conventional D1600-B1600 memory system was 10.4% and 7.6%, respectively with only 2.5% and 0.7% respective performance losses.

In summary, FIGS. 9 and 10 demonstrate that the exemplary decoupled MM memory architecture delivered the same bandwidth as conventional memory systems, using relatively-slower and relatively-power-efficient memory devices with only slight degradation in performance.

Memory Channel Usage for Decoupled MM Memory Systems

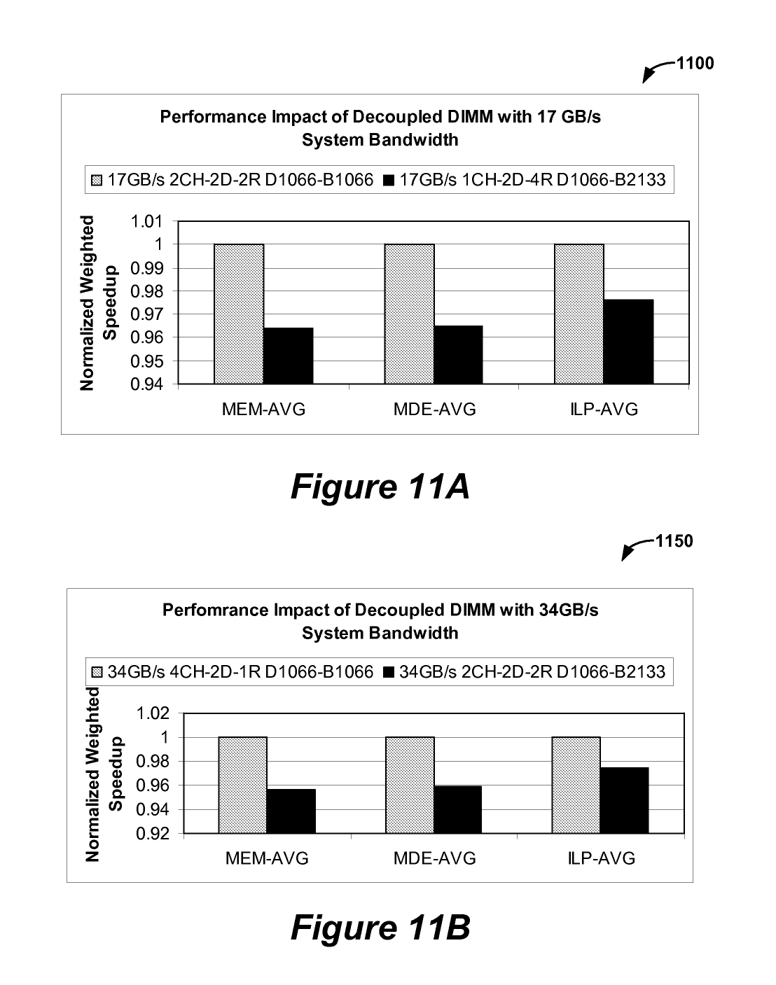

FIGS. 11A and 11B depict performance comparisons 1100 and 1150, respectively, of exemplary memory systems using fewer memory channels than comparable conventional memory systems.

Performance comparison 1100 of FIG. 11A compares a conventional D1066-B1066 memory system with two channels, two memory modules per channel, and two ranks per memory module (2CH-2D-2R) and a D1066-B2133 system with one channel, two memory modules per channel, and four ranks per channel (1CH-2D-4R) configuration. The weighted speedups in FIG. 11A were normalized to weighted speedups of the conventional D1066-B1066 2CH-2D-2R memory system.

As indicated in FIG. 11A, both the conventional D1066-B1066 2CH-2D-2R memory system and the exemplary D1066-B2133 1CH-2D-4R memory system provided 17 GB/s of system bandwidth. The exemplary D1066-B2133 1CH-2D-4R used one less channel than the conventional D1066-B1066 2CH-2D-2R to provide the 17 GB/s of system bandwidth. However, this savings of a whole channel, with its concomitant savings in cost, power, and memory-board space, only incurred a minor performance impact. As indicated by FIG. 11A, the performance losses using the exemplary D1066-B2133 1CH-2D-4R memory system compared to the conventional D1066-B1066 2CH-2D-2R memory system were only 3.6%, 3.5% and 2.4% for MEM-AVG, MDE-AVG and ILP-AVG workloads, respectively.

Similarly, performance comparison 1150 of FIG. 11B compares a conventional D1066-B1066 memory system with four channels, two memory modules per channel and single rank per memory module (4CH-2D-1R) and an exemplary D1066-B2133 memory system with two channels, two memory modules per channel and two ranks per memory module (2CH-2D-2R). The weighted speedups in FIG. 11B were normalized to weighted speedups of the conventional D1066-B1066 4CH-2D-1R memory system.

As indicated in FIG. 11B, both the conventional D1066-B1066 4CH-2D-1R memory system and the exemplary D1066-B2133 2CH-2D-4R memory system provided 34 GB/s of system bandwidth. The exemplary D1066-B2133 2CH-2D-4R used two less channels than the conventional D1066-B1066 4CH-2D-1R to provide the 34 GB/s of system bandwidth.

Again, the savings of two whole channels provided by the exemplary memory system again only incurred a minor performance impact. As indicated in FIG. 11B, the performance loss using the exemplary D1066-B2133 2CH-2D-4R memory system compared to the conventional D1066-B1066 4CH-2D-1R memory system was only 4.4%, 4.1% and 2.5% for MEM-AVG, MDE-AVG and ILP-AVG workloads, respectively.

Thus, compared to conventional designs with more channels, performance losses of exemplary decoupled MM designs with fewer channels are minor. These losses stem from latency overhead introduced by the synchronization device and increased contention on fewer channels.

An Exemplary Computing Device

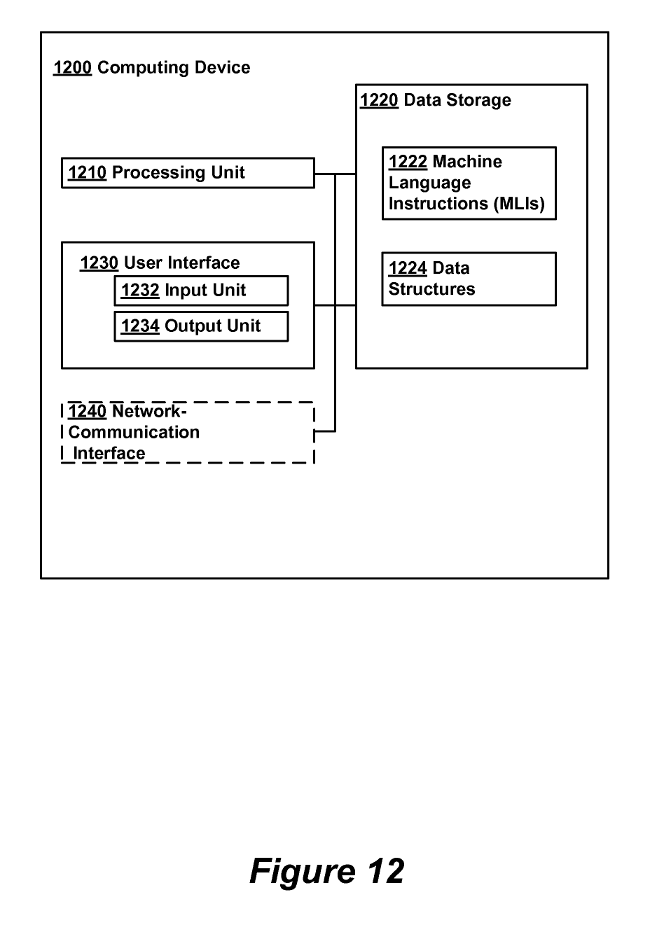

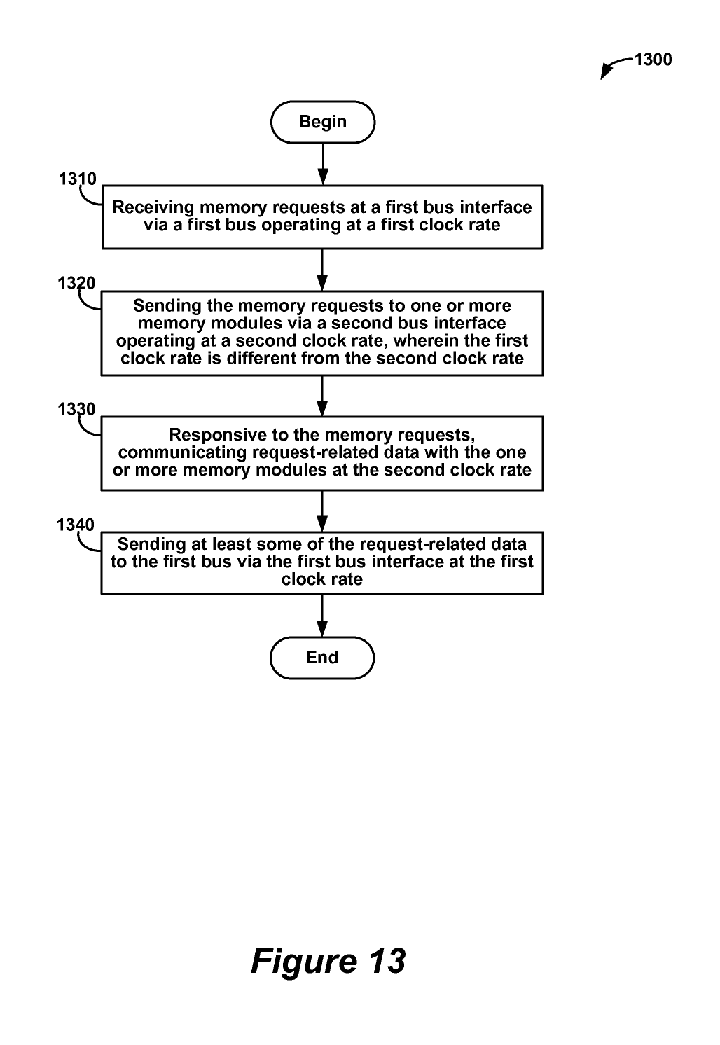

FIG. 12 is a block diagram of an exemplary computing device 1200, comprising processing unit 1210, data storage 1220, user interface 1230, and network-communication interface 1240 in accordance with embodiments of the disclosure. Computing device 1200 can be a desktop computer, laptop or notebook computer, personal data assistant (PDA), mobile phone, embedded processor, or any similar device that is equipped with at least one processing unit capable of executing machine-language instructions that implement at least part of the herein-described methods, including but not limited to method 1300 described in more detail below with respect to FIG. 13, and/or herein-described functionality of an memory simulator.

Processing unit 1210 can include one or more central processing units, computer processors, mobile processors, digital signal processors (DSPs), microprocessors, computer chips, and similar processing units configured to execute machine-language instructions and process data.

Data storage 1220 comprises one or more storage devices with at least enough combined storage capacity to contain machine-language instructions 1222 and data structures 1224. Data storage 1220 can include read-only memory (ROM), random access memory (RAM), removable-disk-drive memory, hard-disk memory, magnetic-tape memory, flash memory, and similar storage devices. In some embodiments, data storage 1220 includes an exemplary decoupled MM memory system.

Machine-language instructions 1222 and data structures 1224 contained in data storage 1220 include instructions executable by processing unit 1210 and any storage required, respectively, to perform at least part of herein-described methods, including but not limited to method 1300 described in more detail below with respect to FIG. 13, and/or herein-described functionality of a memory simulator.

The terms tangible computer-readable medium and tangible computer-readable media refer to any tangible medium that can be configured to store instructions, such as machine-language instructions 1222, for execution by a processing unit and/or computing device; e.g., processing unit 1210. Such a medium or media can take many forms, including but not limited to, non-volatile media and volatile media. Non-volatile media includes, for example, read only memory (ROM), flash memory, magnetic-disk memory, optical-disk memory, removable-disk memory, magnetic-tape memory, hard drive devices, compact disc ROMs (CD-ROMs), direct video disc ROMs (DVD-ROMs), computer diskettes, and/or paper cards. Volatile media include dynamic memory, such as main memory, cache memory, and/or random access memory (RAM). In particular, volatile media may include an exemplary decoupled MM memory system. Many other types of tangible computer-readable media are possible as well. As such, herein-described data storage 1220 can comprise and/or be one or more tangible computer-readable media.

User interface 1230 comprises input unit 1232 and/or output unit 1234. Input unit 1232 can be configured to receive user input from a user of computing device 1200. Input unit 1232 can comprise a keyboard, a keypad, a touch screen, a computer mouse, a track ball, a joystick, and/or other similar devices configured to receive user input from a user of the computing device 1200.

Output unit 1234 can be configured to provide output to a user of computing device 1200. Output unit 1234 can comprise a visible output device for generating visual output(s), such as one or more cathode ray tubes (CRT), liquid crystal displays (LCD), light emitting diodes (LEDs), displays using digital light processing (DLP) technology, printers, light bulbs, and/or other similar devices capable of displaying graphical, textual, and/or numerical information to a user of computing device 1200. Output unit 1234 alternately or additionally can comprise one or more aural output devices for generating audible output(s), such as a speaker, speaker jack, audio output port, audio output device, earphones, and/or other similar devices configured to convey sound and/or audible information to a user of computing device 1200.

Optional network-communication interface 1240, shown with dashed lines in FIG. 12, can be configured to send and receive data over a wired-communication interface and/or a wireless-communication interface. The wired-communication interface, if present, can comprise a wire, cable, fiber-optic link and/or similar physical connection to a data network, such as a wide area network (WAN), a local area network (LAN), one or more public data networks, such as the Internet, one or more private data networks, or any combination of such networks. The wireless-communication interface, if present, can utilize an air interface, such as a ZigBee, Wi-Fi, and/or WiMAX interface to a data network, such as a WAN, a LAN, one or more public data networks (e.g., the Internet), one or more private data networks, or any combination of public and private data networks. In some embodiments, network-communication interface 1240 can be configured to send and/or receive data over multiple communication frequencies, as well as being able to select a communication frequency out of the multiple communication frequency for utilization.

An Exemplary Method for Processing Memory Requests

FIG. 13 is a flowchart depicting exemplary functional blocks of an exemplary method 1300 for processing memory requests.

Initially, as shown at block 1310, memory requests are received at a first bus interface via a first bus. The first bus is configured to operate at a first clock rate and transfer data at a first data rate.

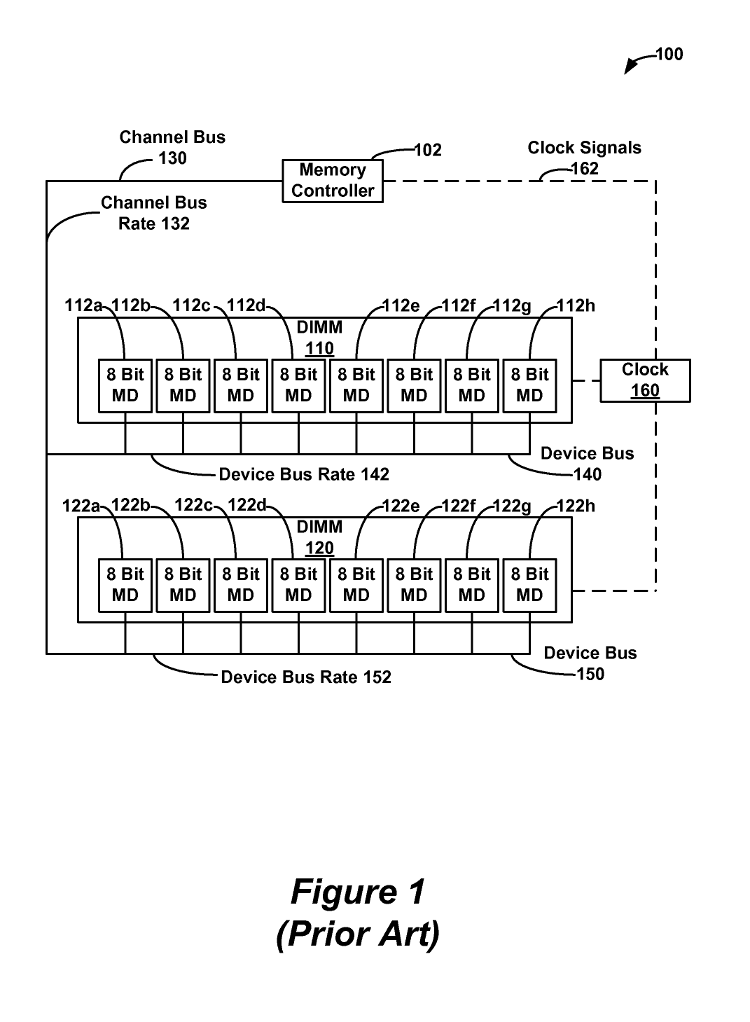

The first bus interface can be a channel bus interface of a synchronization device configured to transfer data with a channel bus operating in accordance with clock signals that oscillate at the first clock rate. Example synchronization devices and channel buses are discussed above with respect to FIGS. 1, 2, 3, and 4B. Example performance results for use of exemplary memory systems using synchronization device(s) in comparison to conventional memory systems are discussed above with respect to FIGS. 5 through 11B. An example computing device 1200 configured to use an exemplary memory system using synchronization device(s) and/or to act as a memory simulator is shown in FIG. 12.

In some embodiments, as discussed above in greater detail at least in the context of FIGS. 2 and 3, the memory requests are transmitted between a control bus of the channel bus and a channel bus control interface of a synchronization device and data related to the memory requests is transferred between a data bus of the channel bus and a channel bus data interface of the synchronization device. In these embodiments, the data bus of the channel bus can operate at the first data rate and the control bus of the channel bus can operate at a rate based on the first clock rate—perhaps the first data rate.

In other embodiments, the memory requests include one or more read requests. Each read request can include a read-row address and a read-column address, as discussed above in greater detail above at least in the context of FIGS. 2, 3, and 4B.

In still other embodiments, the memory requests include one or more write requests. Each write request can include a write-row address, a write-column address, and write data. Upon reception of a write request, the write data can be stored in a buffer, perhaps a write data buffer of a synchronization device, such as discussed above in greater detail above at least in the context of FIG. 2.

As shown at block 1320, the memory requests are sent to one or more memory modules via a second bus interface. The second bus interface is configured to operate at a second clock rate and transfer data at a second data rate. The second data rate is slower than the first data rate.

The second bus interface can be a device bus interface of a synchronization device configured to transfer data with the one or more memory modules via a device bus operating in accordance with clock signals that oscillate at the second clock rate. Example synchronization devices, device buses, and memory modules are discussed above with respect to FIGS. 1, 2, 3, and 4B.

In some embodiments, discussed above in the context of at least FIGS. 2 and 3, the memory requests are transmitted from a device bus control interface of a synchronization device via a control bus of a device bus to the one or more memory modules and data related to the memory requests are transferred between a device bus data interface of the synchronization device and the one or more memory modules via a data bus of the device bus. In these embodiments, the data bus of the device bus can operate at the second data rate and the control bus of the device bus can operate at a rate based on the second clock rate, perhaps the second data rate.

In other embodiments, second clock signals are generated at the second clock rate from first clock signals at the first clock rate. For example, a clock module of a synchronization device can generate the second clock signals at the second clock rate, such as discussed above in greater detail above at least in the context of FIGS. 2 and 3.

In still other embodiments, first and/or second clock signals are received, respectively, by first and/or second external clock sources. The first and second external clock sources can be a common clock source or separate clock sources. Such embodiments are discussed above in greater detail at least in the context of FIG. 3.

As shown at block 1330, in response to the memory requests, request-related data are communicated with the one or more memory modules at the second data rate. For example, a synchronization device can transfer data from a buffer of the synchronization device to the one or more memory modules at the second data rate.

In some embodiments, communicating request-related data with the one or more memory modules at the second data rate includes communicating request-related data with the one or more memory modules using the second clock signals. As mentioned above in the context of block 1320, the second clock signals can be generated by a clock module of a synchronization device based on first clock signals at the first clock rate and/or by external clock sources that are discussed greater detail above at least in the context of FIGS. 2 and 3.

As mentioned above in the context of block 1310, the memory requests can include one or more read requests, such as discussed above in greater detail above at least in the context of FIGS. 2, 3, and 4B. In this context, communicating the request-related data with the one or more memory modules can include receiving read data retrieved from the one or more memory devices at the second data rate. The read data can be addressed and/or otherwise based on the read-row address and the read-column address provided with the read request. The retrieved read data can be stored in a buffer, perhaps a read data buffer of a synchronization device.

As also mentioned above in the context of block 1310, the memory requests can include one or more write requests, such as discussed above in greater detail above at least in the context of FIGS. 2, 3, and 4B. In this context, communicating request-related data with the one or more memory modules can include retrieving the write data from a buffer, perhaps a write data buffer of a synchronization device. The retrieved write data can be sent from the synchronization device to the one or more memory devices at the second data rate.

As shown at block 1340, at least some of the request-related data are sent to the first bus via the first bus interface at the first clock rate. A synchronization device can transfer data, such as read data, from a buffer of the synchronization device to the first bus at the first clock rate.

As also mentioned above in the context of blocks 1320 and 1330, the request-related data can be related to a read request, such as discussed above in greater detail above at least in the context of FIGS. 2, 3, and 4B. In this context, sending at least some of the request-related data to the first bus via the first bus interface at the first clock rate can include retrieving stored read data from a buffer, perhaps a read data buffer of a synchronization device. Then, the synchronization device can send the retrieved read data at the first clock rate via the first bus interface.

Thus, memory requests are processed. Timing and processing of memory requests are discussed above in greater detail with respect to at least FIGS. 1, 2, 3, and 4B. The results of the memory requests (i.e., the request-related data) are suitable for use in by any computing device configured to receive memory requests, such as, but not limited to, computing device 1200.

It should be further understood that this and other arrangements described herein are for purposes of example only. As such, those skilled in the art will appreciate that other arrangements and other elements (e.g., machines, interfaces, functions, orders, and groupings of functions, etc.) can be used instead, and some elements can be omitted altogether according to the desired results. Further, many of the elements that are described are functional entities that can be implemented as discrete or distributed components or in conjunction with other components, in any suitable combination and location.

In view of the wide variety of embodiments to which the principles of the present application can be applied, it should be understood that the illustrated embodiments are examples only, and should not be taken as limiting the scope of the present application. For example, the steps of the flow diagrams can be taken in sequences other than those described, and more or fewer elements can be used in the block diagrams. While various elements of embodiments have been described as being implemented in software, in other embodiments hardware or firmware implementations can alternatively be used, and vice-versa.

The claims should not be read as limited to the described order or elements unless stated to that effect. Therefore, all embodiments that come within the scope and spirit of the following claims and equivalents thereto are claimed.

1. A synchronization device, comprising:
a first bus interface, configured to connect to a first bus, the first bus configured to operate at a first clock rate and to transfer data at a first data rate, the first bus interface comprising a first control interface and a first data interface, the first control interface configured to communicate memory requests based on the first clock rate, and the first data interface configured to communicate request-related data associated with the memory requests at the first data rate;
a buffer, configured to store the memory requests and the request-related data and to connect to the first bus interface and a second bus interface;
the second bus interface, configured to further connect to a second bus and to one or more memory devices, the second bus configured to operate at a second clock rate and transfer data at a second data rate, the second bus interface comprising a second control interface and a second data interface, the second control interface configured to transfer the memory requests from the buffer to the one or more memory devices based on the second clock rate, and the second data interface configured to communicate the request-related data between the buffer and the one or more memory devices at the second data rate; and
a clock module, configured to receive first clock signals at the first clock rate and generate second clock signals at the second clock rate, wherein the first bus interface operates in accordance with the first clock signals and the second bus interface and the one or more memory devices operate in accordance with the second clock signals, and
wherein the second data rate is slower than the first data rate.

2. The synchronization device of claim 1, wherein a ratio of the first clock rate to the second clock rate is an integer greater than one.

3. The synchronization device of claim 2, wherein the clock module further comprises a frequency divider, and wherein the frequency divider is configured to convert the first clock signals at the first clock rate to the second clock signals based on the integer.

4. The synchronization device of claim 1, wherein a ratio of the first clock rate to the second clock rate is not an integer.

5. The synchronization device of claim 4, wherein the clock module further comprises a circuit configured to convert the first clock signals at the first clock rate to the second clock signals based on the ratio of the first clock rate to the second clock rate.

6. The synchronization device of claim 1, wherein the buffer comprises a read buffer, a write buffer, and a request buffer.

7. The synchronization device of claim 1, wherein the buffer is configured to transfer data at least the first data rate and the second data rate.

8. The synchronization device of claim 1, wherein the first bus interface is a parallel bus interface configured to communicate a plurality of bits simultaneously between the first bus and the synchronization device.

9. A memory module, comprising:
a synchronization device, comprising:
a first bus interface configured to connect to a first bus operating at a first clock rate, the first bus configured to communicate memory requests, and
a buffer,
a second bus interface;
one or more memory devices; and
a second bus, configured to connect the second bus interface with the one or more memory devices and to operate at a second clock rate,
wherein the one or more memory devices are configured to communicate request-related data with the synchronization device via the second bus in accordance with the memory requests at a second data rate based on the second clock rate,
wherein the synchronization device is configured to communicate at least some of the request-related data with the first bus at a first data rate based on the first clock rate, and
wherein the second data rate is slower than the first data rate.

10. The memory module of claim 9, wherein the buffer comprises a read data buffer.

11. The memory module of claim 10, wherein the memory requests comprise a read request communicated based on the first clock rate, the read request comprising a read-row address and a read-column address, wherein the request-related data comprise read data retrieved from the one or more memory devices at the second data rate based on the read-row address and read-column address, the read data stored in the read data buffer, and wherein the first bus interface is configured to communicate the stored read data from the read data buffer at the first data rate.

12. The memory module of claim 9, wherein the buffer comprises a write data buffer.

13. The memory module of claim 12, wherein the memory requests comprise a write request, the write request comprising a write-row address and a write-column address, wherein the request-related data comprise write data associated with the write request, wherein the write data are stored in the write data buffer, wherein the second bus interface is configured to communicate the write data stored in the write data buffer at the second clock rate to the one or more memory devices, and wherein the one or more memory devices are configured to stored the communicated write data based on the write-row address and write-column address.

14. A method, comprising:
receiving memory requests at a first bus interface via a first bus, the first bus configured to operate at a first clock rate and to transfer data at a first data rate;
sending the memory requests to one or more memory modules via a second bus interface configured to operate at a second clock rate and transfer data at a second data rate, wherein the second data rate is slower than the first data rate;
responsive to the memory requests, communicating request-related data with the one or more memory modules at the second data rate; and
sending at least some of the request-related data to the first bus via the first bus interface at the first data rate.

15. The method of claim 14, further comprising: generating, at a clock module, second clock signals at the second clock rate from first clock signals at the first clock rate.

16. The method of claim 15, wherein communicating request-related data with the one or more memory modules at the second data rate comprises communicating request-related data with the one or more memory modules using the second clock signals.

17. The method of claim 14, wherein receiving the memory requests comprises receiving a read request comprising a read-row address and a read-column address.

18. The method of claim 17, wherein communicating request-related data with the one or more memory modules comprises:
receiving read data retrieved from the one or more memory devices at the second data rate based on the read-row address and the read-column address, and
storing the retrieved read data in a buffer; and
wherein sending at least some of the request-related data to the first bus via the first bus interface at the first clock rate comprises:
retrieving the stored read data from the buffer; and
sending the retrieved read data at the first data rate.

19. The method of claim 14, wherein receiving the memory requests comprises:
receiving a write request comprising a write-row address, a write-column address, and write data; and
storing the write data in a buffer.

20. The method of claim 19, wherein communicating request-related data with the one or more memory modules comprises:
retrieving the write data from the buffer; and
sending the retrieved write data to the one or more memory devices at the second data rate.

21. The method of claim 14, further comprising:
receiving first clock signals at the first clock rate from a first external clock source; and
receiving second clock signals at the second clock rate from a second external clock source.
